(19) United States
(12) Patent Application Publication
(10) Pub. No.: US 2010/0074628 A1
(43) Pub. Date: Mar. 25, 2010

(54) OPTICAL COMMUNICATION SYSTEM, STATION-SIDE APPARATUS, AND SUBSCRIBER-SIDE APPARATUS

(75) Inventors: Ken Murakami, Tokyo (JP); Tetsuya Yokotani, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: MITSUBISHI ELECTRIC CORPORATION, Chiyoda-ku, Tokyo (JP)

(21) Appl. No.: 12/302,030

(22) PCT Filed: May 8, 2007
(86) PCT No.: PCT/JP2007/059517

§ 371 Date: Feb. 18, 2009

(30) Foreign Application Priority Data
May 24, 2006 (JP) 2006-144605

(51) Int. Cl. H04B 10/04; H04L 9/32

(52) U.S. Cl. 398/182; 713/168

(57) ABSTRACT

An optical communication system connects one to a plurality subscriber-side apparatuses having one to a plurality of subscriber terminals and a station-side apparatus that covers the subscriber-side apparatuses with an optical transmission medium, sets one to a plurality of logical links between the station-side apparatus and each subscriber-side apparatus, and performs a data transfer with an MAC frame using a set logical link. The station-side apparatus and the subscriber-side apparatus transmit control information of a plurality of set logical links by storing the control information in a single MAC frame.

### TECHNICAL FIELD

The present invention relates to an optical communication system in which one to a plurality of subscriber-side apparatuses having one to a plurality of subscriber terminals and a station-side apparatus that covers the subscriber-side apparatuses are connected via an optical transmission medium, one to a plurality of logical links is set between the station-side apparatus and each of the subscriber-side apparatuses, and a data transfer is performed with an MAC frame using the set logical link, and more particularly, to a technology for suppressing a bandwidth when transmitting control information of a plurality of set logical links to the other side apparatus.

### BACKGROUND ART

The Ethernet (Registered Trademark) PON (Passive Optical Network) system is an optical communication system in which a logical link is established between a subscriber-side apparatus and a station-side apparatus, and data transmission and reception is performed with an MAC frame using the established logical link. The basic specification of the Ethernet (Registered Trademark) PON system is standardized in the IEEE 802.3ah, Nonpatent Literature 1.

A conventional Ethernet (Registered Trademark) PON system described in Nonpatent Literature 1 (hereinafter, “an EPON system”) is configured with a station-side apparatus (OLT: Optical Line Terminal), a plurality of subscriber-side apparatus (ONU: Optical Network Unit), an optical splitter, and an optical transmission medium that connects the above components. The logical link, which is a unit of communication in the EPON system, is set at the time when the ONU is connected, by a procedure called a Discovery, and an MAC frame storing user data and control information is exchanged between the OLT and the ONU through the logical link.

When a logical link is established between the ONU and the OLT, the accumulated data amount at the ONU is notified with a REPORT message in an uplink communication from the ONU to the OLT, and a transmission permission time for each ONU is notified with a GATE message in a downlink communication from the OLT to the ONU. By performing the exchange of the GATE/REPORT messages for each logical link, an access control is performed such that MAC frames of the uplink communication from different logical links do not conflict with each other on a PON interface.

The MAC frame containing the GATE/REPORT message is a 64-byte fixed-length frame, which is configured with an MAC header and a payload. In the MAC header, MAC frame information, such as the transmission source and the destination MAC address, are stored. In the payload, the data and the frame check sequence (FCS) used for an error detection of the MAC frame are stored.

When transmitting a REPORT message, the ONU sequentially transmits, a burst overhead, a 12-byte IPG (Inter Packet Gap), an 8-byte preamble, a 64-byte REPORT message, and a burst overhead. Furthermore, when transmitting a data frame following the REPORT message, the ONU sequentially transmits, a burst overhead, a 12-byte IPG, an 8-byte preamble, a 64-byte REPORT message, a 12-byte IPG, an 8-byte preamble, an MAC frame, and a burst overhead.

On the other hand, when transmitting a GATE message, the OLT sequentially transmits, a 12-byte IPG, an 8-byte preamble, and a 64-byte GATE message. Furthermore, when transmitting a data frame following the GATE message, the OLT sequentially transmits, a 12-byte IPG, an 8-byte preamble, a 64-byte GATE message, a 12-byte IPG, an 8-byte preamble, and an MAC frame. That is to say, the burst overhead does not exist in the downlink communication.

Because the exchange of the GATE/REPORT message is performed for each logical link, if the logical link in a PON interface between each ONU and the OLT becomes massive, a bandwidth required for exchanging the messages becomes also massive, bringing a pressured on the PON interface, which is a problem.

In addition, when a logical link is established between an ONU and the OLT, an OAM link is set by a procedure called the OAM Discovery, and a setting information notification to the ONU, an alert notification from the ONU, and the like are exchanged with an OAM frame. Furthermore, during the time when the OAM link is set, the OAM frame is exchanged at regular intervals for a Keep Alive. The OAM frame is contained in the MAC frame, and is exchanged between the OLT and the ONU through the OAM link. Because the exchange of the OAM frame is also performed for each logical link, if the logical link in a PON interface between each ONU and the OLT becomes massive, a bandwidth required for exchanging the messages becomes also massive, bringing a pressured on the PON interface, which is also a problem.

To cope with the above problems, a conventional technology is described in Patent Literature 1. In the technology described in Patent Literature 1, a bandwidth consumption by a control message is suppressed by placing the control information, which is used to be transmitted by the 64-byte MAC frame, in a preamble of the MAC frame.

Patent Literature 1: Japanese Patent Application Laid-open Publication No. 2003-224572

Nonpatent Literature 1: IEEE Std 802.3ah-2004

### DISCLOSURE OF INVENTION

### Problem To Be Solved By the Invention

However, in the conventional technology described in Patent Literature 1, the size of information that can be stored is limited because the control information is stored in the 8-byte preamble of the MAC frame. With the GATE message described in Nonpatent Literature 1, it is necessary to have at least a piece of 4-byte time stamp information, a 1-byte flag, and a piece of 6-byte grant information, which cannot be stored in the 8-byte preamble. Furthermore, with the REPORT message described in Nonpatent Literature 1, it is necessary to have at least a piece of 4-byte time stamp information, a 1-byte queue set number, a 1-byte report bitmap, and a piece of 2-byte report information, which cannot be stored in the 8-byte preamble either. In other words, when the logical link in a PON interface becomes massive, the information to be notified by the control message (GATE/REPORT message) described in Nonpatent Literature 1 cannot be stored in a single preamble with the conventional technology described in Patent Literature 1. Therefore, it is a problem in the conventional technology described in Patent Literature 1 that it is not possible to sufficiently suppress a bandwidth required when notifying all the pieces of information that should be notified by the control message described in Nonpatent Literature 1.

In addition, because the protocol for processing the GATE/REPORT message is positioned at an upper layer of the MAC layer in the conventional technology described in Nonpatent Literature 1, a 12-byte IPG, an 8-byte preamble, a 16-byte MAC header, and a 4-byte FCS must be added to the messages, which is another factor to make the required bandwidth massive.

The present invention has been achieved in consideration of the above-described facts, and it is an object of the present invention to achieve an optical communication system that can transfer least necessary information as the control information with a less bandwidth by storing control information of a plurality of logical links in a single MAC frame and transmitting it, even when the logical link in the PON interface becomes massive.

### Means For Solving Problem

To solve the above problems and to achieve the object, an optical communication system according to the present invention connects one to a plurality of subscriber-side apparatuses having one to a plurality of subscriber terminals and a station-side apparatus that covers the subscriber-side apparatuses with an optical transmission medium, sets one to a plurality of logical links between the station-side apparatus and each subscriber-side apparatus, and performs a data transfer with an MAC frame using a set logical link. The station-side apparatus and the subscriber-side apparatus transmit control information of a plurality of set logical links by storing the control information in a single MAC frame.

### Effect of the Invention

According to the present invention, because the control information of a plurality of logical links is not transmitted by using a separate MAC frame for each logical link but is transmitted by storing it in a single MAC frame, there is an effect of achieving an optical communication system that can transfer least necessary information as the control information with a less bandwidth.

### BRIEF DESCRIPTION OF DRAWINGS

FIG. 1 is a schematic diagram of a configuration of an optical communication system according to the present invention.

FIG. 2 is a schematic diagram illustrating a format of a GATE message according to an embodiment 1.

FIG. 3 is a schematic diagram illustrating a format of a conventional GATE message.

FIG. 4 is a graph showing a bandwidth required for the GATE message.

FIG. 5 is a graph showing a bandwidth required for the GATE message.

FIG. 6 is a schematic diagram for explaining a method of storing information on an encryption.

FIG. 7 is a schematic diagram illustrating a relationship between a method of storing grant setting information, an LLID value to be included in a preamble, and an encryption/decryption method.

FIG. 8 is a block diagram illustrating a configuration of an OLT according to the embodiment 1.

FIG. 9 is a block diagram illustrating a configuration of an ONU according to the embodiment 1.

FIG. 10 is a flowchart for explaining an operation of the OLT according to the embodiment 1.

FIG. 11 is a flowchart for explaining an operation of the ONU according to the embodiment 1.

FIG. 12 is a schematic diagram illustrating a format of a REPORT message according to an embodiment 2.

FIG. 13 is a schematic diagram for explaining a burst overhead.

FIG. 14 is a schematic diagram illustrating the maximum value of the burst overhead.

FIG. 15 is a schematic diagram illustrating a format of a conventional REPORT message.

FIG. 16 is a graph showing a bandwidth required for the REPORT message.

FIG. 17 is a schematic diagram illustrating the value of the burst overhead.

FIG. 18 is a graph showing a bandwidth required for the REPORT message.

FIG. 19 is a flowchart for explaining an operation of the ONU according to the embodiment 2.

FIG. 20 is a schematic diagram for explaining a protocol stack according to an embodiment 3.

FIG. 21 is a schematic diagram for explaining a conventional protocol stack.

FIG. 22 is a block diagram illustrating a configuration of an OLT according to the embodiment 3.

FIG. 23 is a block diagram illustrating a configuration of an ONU according to the embodiment 3.

FIG. 24 is a schematic diagram illustrating a format of a GATE message according to the embodiment 3.

FIG. 25 is a graph showing a bandwidth required for the GATE message.

FIG. 26 is a graph showing a bandwidth required for the GATE message.

FIG. 27 is a schematic diagram illustrating a format of a REPORT message according to the embodiment 3.

FIG. 28 is a schematic diagram illustrating a format of a GATE message according to an embodiment 4.

FIG. 29 is a schematic diagram illustrating a format of a REPORT message according to the embodiment 4.

FIG. 30 is a graph showing a bandwidth required for the GATE message.

FIG. 31 is a graph showing a bandwidth required for the GATE message.

FIG. 32 is a schematic diagram for explaining a protocol stack according to an embodiment 5.

FIG. 33 is a block diagram illustrating a configuration of an OLT according to the embodiment 5.

FIG. 34 is a block diagram illustrating a configuration of an ONU according to the embodiment 5.

FIG. 35 is a schematic diagram illustrating a format of an OAM frame according to the embodiment 5.

### EXPLANATIONS OF LETTERS OR NUMERALS

1, 1a, 1b OLT
3, 3a, 3b ONU
5 Optical splitter
7 Optical transmission medium
11 NNI unit
12, 14, 32, 34 MAC unit
13, 33 PON control unit
15 Encrypting unit
16, 37 Optical transceiving unit
31 UNI unit
35 Decrypting unit
36 Frame buffer unit
131 REPORT processing unit
141, 341 OAM transmitting unit
142, 342 OAM receiving unit
132 DBA unit
133 GATE generating unit
331 GATE processing unit
332 REPORT generating unit

### BEST MODE(S) FOR CARRYING OUT THE INVENTION

Exemplary embodiments of an optical communication system and a station apparatus according to the present invention will be explained in detail below with reference to the accompanying drawings. It should be mentioned that the present invention is not to be considered limited to the embodiments.

### Embodiment 1

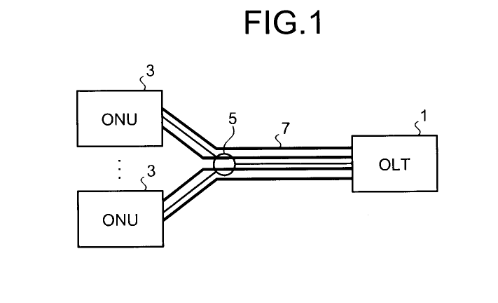

An embodiment 1 of the present invention will be explained with reference to FIGS. 1 to 11. FIG. 1 is a schematic diagram of a configuration of an Ethernet (Registered Trademark) PON (Passive Optical Network) system (hereinafter, “an EPON system”), which is an optical communication system according to the present invention. As shown in FIG. 1, the EPON system includes a station-side apparatus (OLT: Optical Line Terminal) 1, a plurality of subscriber-side apparatuses (ONU: Optical Network Unit) 3, an optical splitter 5, and an optical transmission medium 7 that connects these components to each other.

The logical link, which is a unit of communication in the EPON system, is set by a procedure called Discovery defined in Nonpatent Literature 1 at the time when the ONU 3 is connected, and the MAC frame storing user data and control information is exchanged between the OLT 1 and the ONU 3 through the logical link.

With an establishment of a logical link between the OLT 1 and the ONU 3, the accumulated data amount at the ONU 3 is notified with a REPORT message in an uplink communication from the ONU 3 to the OLT 1, and a transmission permission time for each ONU 3 is notified with a GATE message in a downlink communication from the OLT 1 to the ONU 3. By performing the exchange of the GATE/REPORT messages for each logical link, an access control is performed such that MAC frames of the uplink communication from different logical links do not conflict with each other on a PON interface.

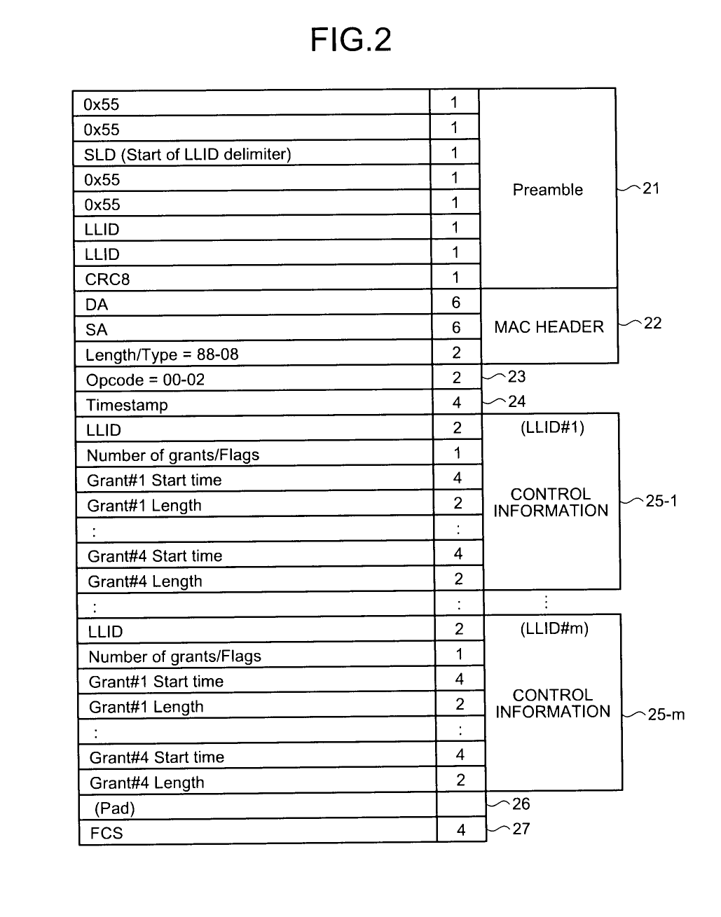

Firstly, a method of storing grant setting information in a GATE message according to the present invention will be explained. FIG. 2 is a schematic diagram illustrating a format of the GATE message used in the EPON system according to the present invention. The GATE message used in the EPON system according to the present invention, which is shown in FIG. 2, shows a case where m (m is a positive integer) logical links are set on the OLT 1, and the number of pieces of grant setting information for each of the logical links is four. The GATE message used in the EPON system according to the present invention is configured with an 8-byte preamble 21, a 14-byte MAC header 22, a 2-byte Opcode 23, a 4-byte time stamp 24, a 27-byte control information 25-1 to 25-m, a padding (Pad) 26, and a 4-byte frame sequence check (FCS) 27.

The preamble 21 is configured with unused areas located at the first, the second, the fourth, and the fifth bytes for storing a reserve value “0x55”, an SLD (Start of LLID Delimiter) located at the third byte for storing information indicating that an LLID is stored in the preamble 21, an LLID located at the sixth and the seventh bytes for storing a value of a logical link identifier (LLID: Logical Link Identifier) for identifying the logical link, and a CRC 8 located at the eighth byte for storing a code for a code error check for areas from the SLD to the LLID.

The MAC header 22 is configured with a 6-byte DA for storing a destination MAC address of the GATE message, a 6-byte SA for storing a transmission source MAC address of the GATE message, and a 2-byte Length/Type for storing type information (88-08) meaning an MAC control message.

The Opcode 23 stores a code (00-02) indicating a GATE message. The time stamp 24 stores time information.

The control information 25-1 to 25-m is configured with a 2-byte LLID for storing an LLID value for identifying a logical link indicated by the control information stored in the field of the control information 25-1 to 25-m and a 25-byte grant information for storing grant setting information, which is information on the start time and the length corresponding to a grant (Number of grants/Flags, Grant#1 Start Time, Grant#1 Length, Grant#2 Start Time, Grant#2 Length, Grant#3 Start Time, Grant#3 Length, Grant#4 Start Time, Grant#4 Length).

The Pad 26 is an area for adjusting a frame length such that the frame length of the GATE message (from the MAC header 22 to the FCS 27) becomes at least 64 bytes, in which a value 0 is stored. The FCS 27 stores a code for detecting an error in the GATE message.

In this manner, in the GATE message of the EPON system according to the present invention, the LLID for storing the LLID value for identifying which logical link the grant setting information stored in the grant information is for is provided in the control information 25-1 to 25-m for each logical link, to store the grant setting information on the m logical links in a single GATE message. With this scheme, the frame length of the GATE message used in the EPON system according to the present invention can be expressed in the number of bytes as

Frame length of GATE message=44+m(3+6n) including a 12-byte IPG (Inter Packet Gap) and the 8-byte preamble, where m is the number of logical links and n is the number of grants per logical link.

Furthermore, in the GATE message of the EPON system according to the present invention, the number of bytes of a payload of the GATE message is variable according to the number of logical links m and the number of grants per logical link n to store the pieces of grant setting information on m logical links in a single GATE message. Therefore, if the frame length of the GATE message exceeds the predetermined maximum frame length of the MAC frame, the frame of the GATE message is divided into a plurality of MAC frames.

The method of storing the grant setting information in the grant information of the control information 25-1 to 25-m includes two methods, (method 1) and (method 2), as described below.

(method 1) To store grant setting information on all logical links set on the same ONU 3.

(method 2) To store grant setting information on all logical links set on the same PON interface.

When establishing a logical link, the OLT 1 manages which logical link is set on which ONU 3, and therefore, it can determine grant setting information to be stored in a single GATE message in the (method 1).

Meanwhile, the ONU 3 is notified with an LLID value indicating an established logical link from the OLT 1 when the logical link is established. If the LLID value stored in the LLID of the control information 25-1 to 25-m of a received GATE message matches with the notified LLID value, the ONU 3 recognizes that the control information 25-1 to 25-m is for its own logical link, and performs a process based on the grant setting information stored in the grant information. On the other hand, if the LLID value stored in the LLID of the control information 25-1 to 25-m of a received GATE message does not match with the notified LLID value, the ONU 3 recognizes that the control information 25-1 to 25-m is not for its own logical link, and discards the grant setting information stored in the grant information.

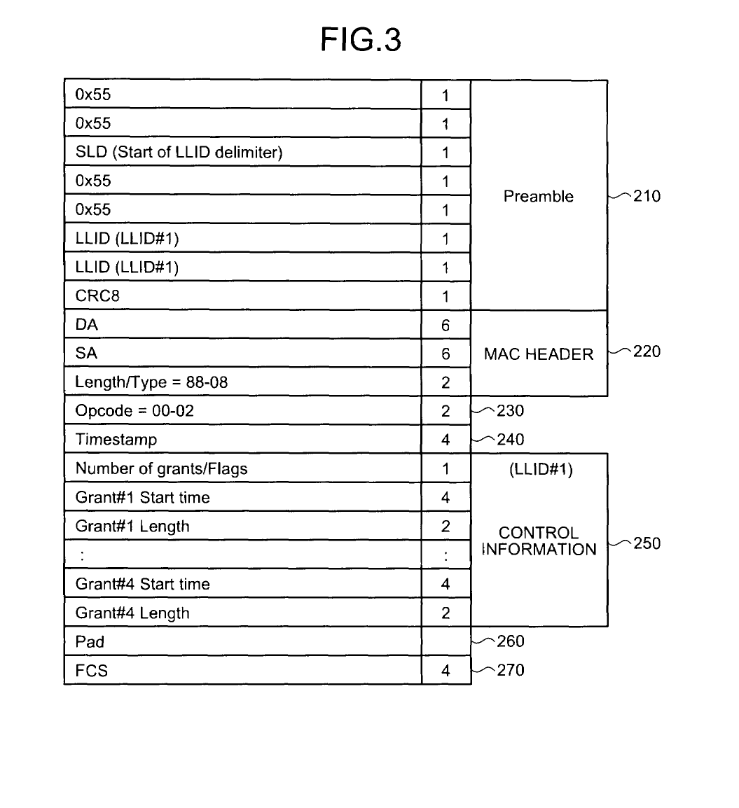

FIG. 3 is a schematic diagram illustrating a format of a GATE message used in the conventional EPON system described in Nonpatent Literature 1. As shown in FIG. 3, the conventional GATE message is configured with a preamble 210, an MAC header 220, an Opcode 230, a time stamp 240, control information 250, a Pad 260, and an FCS 270. The preamble 210, the MAC header 220, the Opcode 230, the time stamp 240, the Pad 260, and the FCS 270 are same as the preamble 21, the MAC header 22, the Opcode 23, the time stamp 24, the Pad 26, and the FCS 27 shown in FIG. 2.

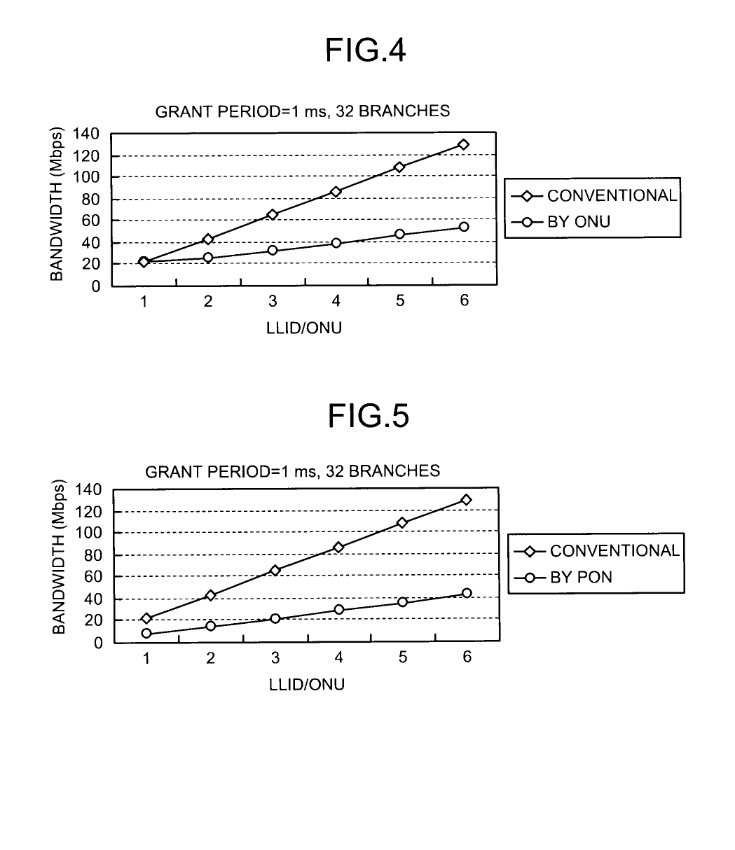

The difference is that only the control information 250 of a single logical link (LLID#1 in the case shown in FIG. 3) is set in the GATE frame, and in the control information 250, the LLID of the control information 25 in the GATE frame according to the present invention shown in FIG. 4 is deleted. In other words, the GATE message used in the conventional EPON system shown in FIG. 3 notifies the grant information on m logical links with m 64-byte MAC frames, while the GATE message used in the EPON system according to the present invention notifies the grant information on m logical links with a single MAC frame.

FIGS. 4 and 5 shows a bandwidth required for the GATE message when the number of ONUs 3 connected to the PON interface (covered by the OLT 1) is set to 32, the number of grants per logical link n is set to “4”, and a period of generating the GATE message is set to 1 ms.

In FIG. 4, the vertical axis represents the bandwidth, and the horizontal axis represents the number of logical links belonging to a single ONU 3. The symbol “⋄” indicates the required bandwidth when using the GATE message of the conventional EPON system shown in FIG. 3, and the symbol “o” indicates the required bandwidth when using the GAPE message of the EPON system according to the present invention shown in FIG. 2, which stores the grant setting information in units of ONU by the (method 1).

In FIG. 5, the vertical axis represents the bandwidth, and the horizontal axis represents the number of logical links belonging to a single ONU 3. The symbol “⋄” indicates the required bandwidth when using the GATE message of the conventional EPON system shown in FIG. 3, and the symbol “o” indicates the required bandwidth when using the GAPE message of the EPON system according to the present invention shown in FIG. 2, which stores the grant setting information in units of PON by the (method 2).

As shown in FIGS. 4 and 5, the case of using the GATE message of the EPON system according to the present invention in which the grant setting information is stored by the (method 1) or the (method 2) requires less bandwidth than the case of using the GATE message of the conventional EPON system, and the difference in the required bandwidth increases as the number of logical links belonging to a single ONU 3 increases. In other words, as the number of logical links belonging to a single ONU 3 increases, the effect of suppressing the bandwidth by the method of storing the grant setting information in the EPON system according to the present invention increases.

The LLID value stored in the LLID of the preamble 21 of the GATE message will be explained. When storing the grant setting information by the (method 1), the LLID value stored in the LLID of the preamble 21 includes two types of values, (setting value 1) and (setting value 2), as described below.

(setting value 1) Any one of LLID values indicating logical links corresponding to the grant setting information stored in the grant information of the control information 25-1 to 25-m of the GATE message (LLID value for unicast)

(setting value 2) LLID value for broadcast (“0xFFFF” defined in Nonpatent Literature 1)

When the LLID value included in the preamble of the MAC frame transmitted by the OLT 1 matches with the LLID value indicating its own logical link or the LLID value for broadcast, the ONU 3 recognizes that the MAC frame is for itself, and when the LLID value included in the preamble does not match with the LLID value indicating its own logical link, it recognizes that the MAC frame is not for itself, and discards the MAC frame. Therefore, when the OLT 1 sets the (setting value 1) in the LLID of the preamble 21 of the GATE message, the ONU 3 recognizes that the GATE message is for itself, receives the GATE message, and performs a process based on the grant setting information for its own logical link.

On the other hand, when the OLT 1 sets the (setting value 2) in the LLID of the preamble 21 of the GATE message, all of the ONUs 3 receive the GATE message. When the LLID value stored in the LLID of the control information 25-1 to 25-m of the received GATE message matches with the LLID value notified to itself, it recognizes that the control information 25-1 to 25-m is for its own logical link, and performs a process based on the grant setting information stored in the grant information.

On the other hand, when the LLID value stored in the LLID of the control information 25-1 to 25-m of the received GATE message does not match with the LLID value notified to itself, it recognizes that the control information 25-1 to 25-m is not for its own logical link, and discards the grant setting information.

When the grant setting information is stored by the (method 2), since the control information 25-1 to 25-m of the GATE message includes grant setting information for logical links of a plurality of ONUs 3, if the (setting value 1) is stored in the LLID of the preamble 21, the ONUs 3 other than the ONU 3 having the logical link indicated by the LLID value discard the GATE message. Therefore, when storing the grant setting information by the (method 2), the OLT stores the (setting value 2) in the LLID of the preamble 21.

An encryption/decryption method for the GATE message will be explained. The encryption/decryption method includes three methods, (method A) to (method C), as describe below.

(method A) The OLT 1 transmits the grant setting information of each logical link stored in the GATE message by encrypting it with an encryption key that is managed for each logical link, and the ONU 3 decrypts the grant setting information of the logical link stored in the GATE message with a decryption key that is managed for each logical link.

(method B) The OLT 1 encrypts the GATE message with an encryption key that is managed in the logical link indicated by the LLID value stored in the LLID of the preamble 21, and the ONU 3 decrypts the GATE message with a decryption key that is managed in the logical link indicated by the LLID value stored in the LLID of the preamble 21 of the GATE message.

(method C) The OLT 1 encrypts the GATE message with an encryption key that is managed by the LLID value for broadcast, and the ONU 3 decrypts the GATE message with a decryption key that is managed by the LLID value for broadcast.

The OLT 1 manages one to a plurality of encryption keys in association with the LLID value, i.e., one to a plurality of encryption keys in association with the LLID value indicating a logical link for each logical link and one to a plurality of encryption keys in association with the LLID value for broadcast. On the other hand, the ONU 3 manages one to a plurality of decryption keys in association with the LLID value, i.e., one to a plurality of decryption keys in association with the LLID value indicating a logical link for each logical link and one to a plurality of decryption keys in association with the LLID value for broadcast.

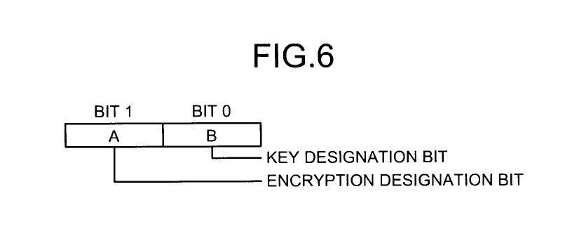

Generally, when transmitting an MAC frame, it is necessary to notify encryption information indicating whether the MAC frame is encrypted or not and key information indicating which encryption key is used when encrypting the MAC frame. For example, when two encryption keys are managed in association with one LLID value, as shown in FIG. 6, a 2-bit information including an encryption designation bit for storing encryption information and a key designation bit for storing key information is required. The OLT 1 stores the encryption information in the encryption designation bit, and stores the key information in the key designation bit. The ONU 3 selects whether to decrypt the MAC frame and a key for decrypting the MAC frame based on the encryption information stored in the encryption designation bit and the key information stored in the key designation bit.

When applying the (method A), the OLT 1 encrypts the frame from the grant number/flag of the control information 25-1 to 25-m to the last Grant#n Length of the control information 25-1 to 25-m (Grant#4 Length in the case shown in FIG. 2) with one of the encryption keys managed in association with the LLID value stored in the LLID of the control information 25-1 to 25-m of the GATE message. The OLT 1 uses the upper two bits of the LLID of the control information 25-1 to 25-m as the encryption designation bit and the key designation bit, stores the encryption information indicating that the frame is encrypted in the encryption designation bit, and stores the key information used when encrypting the frame in the key designation bit. The ONU 3 recognizes whether the frame is encrypted or not and the key used for the encryption by the encryption designation bit and the key designation bit. When the logical link indicated by the LLID value stored in the LLID of the control information 25-1 to 25-m of the GATE message is set on itself, the ONU 3 manages the decryption key corresponding to the encryption key. Therefore, the ONU 3 can correctly decrypt the frame from the grant number/flag of the control information 25-1 to 25-m to the last Grant#4 Length if the logical link indicated by the LLID value stored in the LLID of the control information 25-1 to 25-m of the GATE message is set on itself. However, if the logical link indicated by the LLID value stored in the LLID of the control information 25-1 to 25-m of the GATE message is not set on itself, the ONU 3 cannot correctly decrypt the frame from the grant number/flag of the control information 25-1 to 25-m to the last Grant#4 Length. In other words, only the ONU 3 on which the logical link indicated by the LLID value stored in the LLID of the control information 25-1 to 25-m is set can decrypt the grant setting information of the logical link.

When applying the (method B), the OLT 1 encrypts the GATE message from the DA of the MAC header 22 to the FCS 27 with one of the encryption keys managed in association with the LLID value stored in the LLID of the preamble 21, i.e., the LLID value for unicast, which is one of the LLID values stored in the LLID of the control information 25-1 to 25-m. The OLT 1 uses unused areas of the preamble 21 as the encryption designation bit and the key designation bit, stores the encryption information indicating that the frame is encrypted in the encryption designation bit, and stores the key information used when encrypting the frame in the key designation bit. The ONU 3 recognizes whether the frame is encrypted or not and the key used for the encryption by the encryption designation bit and the key designation bit. When the logical link indicated by the LLID value stored in the LLID of the preamble 21 of the GATE message is set on itself, the ONU 3 manages the decryption key corresponding to the encryption key. Therefore, the ONU 3 can correctly decrypt the GATE message from the DA of the MAC header 22 to the FCS 27 if the logical link indicated by the LLID value stored in the LLID of the preamble 21 of the GATE message is set on itself. However, if the logical link indicated by the LLID value stored in the LLID of the preamble 21 of the GATE message is not set on itself, the ONU 3 cannot correctly decrypt the GATE message from the DA of the MAC header 22 to the FCS 27. In other words, only the ONU 3 on which the logical link indicated by the LLID value stored in the LLID of the preamble 21 is set can decrypt the GATE message.

When applying the (method C), the OLT 1 encrypts the GATE message from the DA of the MAC header 22 to the FCS 27 with one of the encryption keys managed in association with the LLID value stored in the LLID of the preamble 21, i.e., the LLID value for broadcast. The OLT 1 uses unused areas of the preamble 21 as the encryption designation bit and the key designation bit, stores the encryption information indicating that the frame is encrypted in the encryption designation bit, and stores the key information used when encrypting the frame in the key designation bit. The ONU 3 recognizes whether the frame is encrypted or not and the key used for the encryption by the encryption designation bit and the key designation bit. All of the ONUs 3 manages the decryption keys corresponding to the LLID value for broadcast. Therefore, all of the ONUs 3 can correctly decrypt the GATE message from the DA of the MAC header 22 to the FCS 27. In other words, if the (method C) is applied alone, the other ONUs 3 can see the grant setting information of the logical link, which is not desirable in terms of the security. Therefore, it is preferable to use the (method C) together with the (method A).

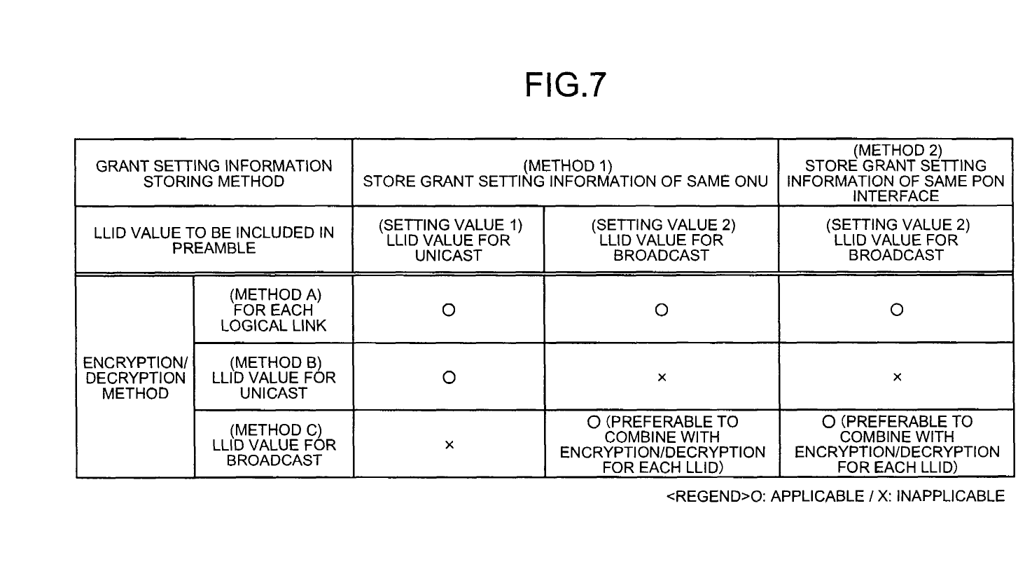

It depends on the method of storing the grant setting information in the GATE message and the setting value stored in the LLID of the preamble 21 whether the (method A) to the (method C) can be applied or not. FIG. 7 is a schematic diagram illustrating a relationship between the method of storing grant setting information, the LLID value to be included in the preamble, and the encryption/decryption method. As shown in FIG. 7, when the (method 1) is used as the method of storing the grant setting information to store the grant setting information of the same ONU in the GATE message and store the (setting value 1), which is the LLID value for unicast, in the LLID of the preamble 21, the (method A) that encrypts/decrypts the grant setting information of each logical value with the encryption key/decryption key for each logical link and the (method B) that encrypts/decrypts the GATE message with the encryption key/decryption key of the LLID for unicast stored in the LLID of the preamble 21 can be applied, but the (method C) that encrypts/decrypts the GATE message with the encryption key/decryption key of the LLID for broadcast stored in the LLID of the preamble 21 cannot be applied.

When the (method 1) is used as the method of storing the grant setting information to store the grant setting information of the same ONU in the GATE message and store the (setting value 2), which is the LLID value for broadcast, in the LLID of the preamble 21, the (method A) that encrypts/decrypts the grant setting information of each logical value with the encryption key/decryption key for each logical link and the (method C) that encrypts/decrypts the GATE message with the encryption key/decryption key of the LLID for broadcast stored in the LLID of the preamble 21 can be applied, but the (method B) that encrypts/decrypts the GATE message with the encryption key/decryption key of the LLID for unicast stored in the LLID of the preamble 21 cannot be applied.

When the (method 2) is used as the method of storing the grant setting information to store the grant setting information of the same PON in the GATE message and store the (setting value 2), which is the LLID value for broadcast, in the LLID of the preamble 21, the (method A) that encrypts/decrypts the grant setting information of each logical value with the encryption key/decryption key for each logical link and the (method C) that encrypts/decrypts the GATE message with the encryption key/decryption key of the LLID for broadcast stored in the LLID of the preamble 21 can be applied, but the (method B) that encrypts/decrypts the GATE message with the encryption key/decryption key of the LLID for unicast stored in the LLID of the preamble 21 cannot be applied.

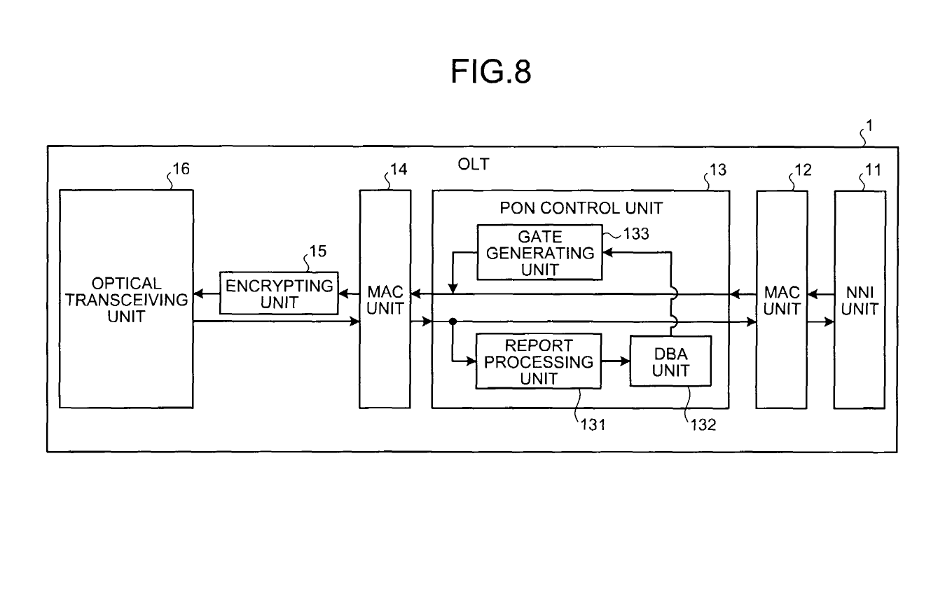

FIG. 8 is a block diagram illustrating a configuration of the OLT 1 to which the method of storing the grant setting information and the encryption/decryption method are applied. As shown in FIG. 8, the OLT 1 includes an NNI (Network Node Interface) unit 11, an MAC unit 12, a PON control unit 13, an MAC unit 14, an encrypting unit 15, and an optical transceiving unit 16. The NNI unit 11 is an interface with an upper network side. The MAC unit 12 performs an upper network side MAC layer process. The PON control unit 13 performs an access control and a logical link control with respect to a PON interface side. The MAC unit 14 performs a PON interface side MAC layer process. The encrypting unit 15 encrypts a downlink MAC frame. The optical transceiving unit 16 performs an optical/electrical conversion.

The PON control unit 13 includes a REPORT processing unit 131, a DBA (Dynamic Bandwidth Allocation) unit 132, and a GATE generating unit 133. The REPORT processing unit 131 processes a REPORT message from the ONU 3. The DBA unit 132 determines the grant setting information for each logical link from the contents of the REPORT message. The GATE generating unit 133 generates a GATE message based on the grant setting information determined by the DBA unit 132.

The GATE generating unit 133 realizes the method of storing the grant setting information describe above, the (method 1) or the (method 2), based on a setting value of a grant setting information storing register (not shown). Specifically, when the setting value of the grant setting information storing register indicates the same ONU mode, the GATE generating unit 133 realizes the (method 1), i.e., stores the grant setting information on all logical links set on the same ONU 3 in the grant information of the control information 25-1 to 25-m. The PON control unit 13 stores logical link management information for managing which logical link is set on which ONU 3 when establishing a logical link with the ONU 3. The GATE generating unit 133 determines the grant information for each logical link to be stored in the control information 25-1 to 25-m based on the logical link management information.

When the setting value of the grant setting information storing register indicates the same PON mode, the GATE generating unit 133 realizes the (method 2), i.e., stores the grant setting information on all logical links set on the same PON interface in the grant information of the control information 25-1 to 25-m of the GATE message.

The MAC unit 14 stores the (setting value 1) or the (setting value 2) in the LLID of the preamble 21, based on a setting value of an LLID setting register (not shown). Specifically, when the setting value of the LLID setting register indicates the unicast mode, the MAC unit 14 stores the (setting value 1), i.e., one of the LLID values stored in the LLID of the control information 25-1 to 25-m (LLID value for unicast), in the LLID of the preamble 21. On the other hand, when the setting value of the LLID setting register indicates the broadcast mode, the MAC unit 14 stores the LLID value for broadcast (“0xFFFF” defined in Nonpatent Literature 1) in the LLID of the preamble 21. As described above, the ONU 3 recognizes whether the MAC frame if for itself or not based on whether the LLID value stored in the LLID of the preamble matches with the LLID value of the logical link set on itself or the LLID value for broadcast. When the value of the grant information storing register indicates the same PON mode, if an LLID value for unicast is set in the LLID of the preamble 21, the ONUs 3 other than the ONU 3 having the logical link indicated by the LLID value cannot determine that the GATE message is for themselves, because the grant information for a plurality of logical links of the ONU 3 is included in the control information 25-1 to 25-m of the GATE message. Therefore, when the value indicating the same PON mode is set in the grant information storing register, the value indicating the broadcast mode should be set in the LLID setting register, inhibiting a setting of the value indicating the unicast.

The encrypting unit 15 manages one to a plurality of encryption keys in association with the LLID value, i.e., one to a plurality of encryption keys in association with the LLID value indicating a logical link for each logical link and one to a plurality of encryption keys in association with the LLID value for broadcast, and performs an encryption by the (method A) to the (method C) based on a setting value of an encryption register (not shown). Specifically, when the setting value of the encryption register indicates the (method A), i.e., the local encryption mode that encrypts the grant information only, the encrypting unit 15 encrypts the frame from the grant number/flag of the control information 25-1 to 25-m to the last Grant#n Length of the control information 25-1 to 25-m with one of the encryption keys managed in association with the LLID value stored in the LLID of the control information 25-1 to 25-m of the GATE message, and stores the encryption information indicating that the frame is encrypted and the key information for identifying the encryption key used when encrypting the frame in the encryption designation bit and the key designation bit at the upper 2 bits of the LLID of the control information 25-1 to 25-m, respectively.

When the setting value of the encryption register indicates the (method B) or the (method C), i.e., the global encryption mode that encrypts the entire GATE message, the encrypting unit 15 encrypts the GATE message from the DA of the MAC header 22 to the FCS 27 with one of the encryption keys managed in association with the LLID value stored in the LLID of the preamble 21, and stores the encryption information indicating that the frame is encrypted and the key information for identifying the encryption key used when encrypting the frame in the encryption designation bit and the key designation bit at the unused areas of the preamble 21, respectively.

When the setting value of the encryption register indicates a combination of the (method A) and the (method B) or the (method C), i.e., a combination mode combining the local encryption mode with the global encryption mode, the encrypting unit 15 encrypts the frame from the grant number/flag of the control information 25-1 to 25-m to the last Grant#n Length of the control information 25-1 to 25-m with one of the encryption keys managed in association with the LLID value stored in the LLID of the control information 25-1 to 25-m of the GATE message, and stores the encryption information indicating that the frame is encrypted and the key information for identifying the encryption key used when encrypting the frame in the encryption designation bit and the key designation bit at the upper 2 bits of the LLID of the control information 25-1 to 25-m, respectively. After that, the encrypting unit 15 encrypts the GATE message from the DA of the MAC header 22 to the FCS 27 with one of the encryption keys managed in association with the LLID value stored in the LLID of the preamble 21, and stores the encryption information indicating that the frame is encrypted and the key information for identifying the encryption key used when encrypting the frame in the encryption designation bit and the key designation bit at the unused areas of the preamble 21, respectively.

When the setting value of the encryption register indicates a unencryption mode that does not perform an encryption, the encrypting unit 15 stores encryption information indicating that the encryption is not performed in the encryption designation bit of the LLID of the control information 25-1 to 25-m of the GATE message and the encryption designation bit at the unused areas of the preamble 21.

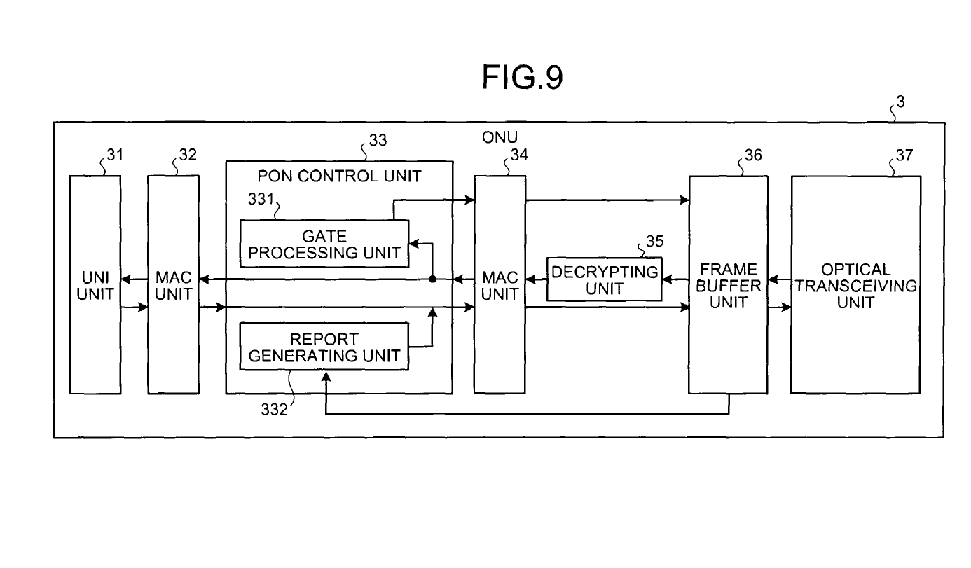

FIG. 9 is a block diagram illustrating a configuration of the ONU 3 to which the method of storing the grant setting information and the encryption/decryption method are applied. As shown in FIG. 9, the ONU 3 includes a UNI (User Network Interface) unit 31, an MAC unit 32, a PON control unit 33, an MAC unit 34, a decrypting unit 35, a frame buffer unit 36, and an optical transceiving unit 37. The UNI unit 31 is a user side interface. The MAC unit 32 performs a user side MAC layer process. The PON control unit 33 performs a frame transmission timing control and a logical link control with respect to a PON interface side. The MAC unit 34 performs a PON interface side MAC layer process. The decrypting unit 35 decrypts a downlink MAC frame. The frame buffer unit 36 is a queue for storing an uplink/downlink MAC frame. The optical transceiving unit 37 performs an optical/electrical conversion.

The PON control unit 33 includes a GATE processing unit 331 and a REPORT generating unit 332. The GATE processing unit 331 processes a GATE message from the OLT 1, and determines an uplink frame transmission timing. The REPORT generating unit 332 generates a REPORT message by monitoring the state of the frame buffer unit and determining queue information to be notified to the OLT.

The decrypting unit 35 manages one to a plurality of decryption keys in association with the LLID value, i.e., one to a plurality of decryption keys in association with the LLID value indicating a logical link for each logical link and one to a plurality of decryption keys in association with the LLID value for broadcast, and performs a decryption by the (method A) to the (method C) based on the encryption information and the key information stored in the encryption designation bit and the key designation bit at the unused areas of the preamble 21 of the GATE message.

Specifically, when the encryption information stored in the encryption designation bit at the unused area of the preamble 21 of the GATE message indicates that the frame is encrypted, the decrypting unit 35 selects a decryption key indicated by the key information stored in the key designation bit at the unused area of the preamble 21 from among the decryption keys corresponding to the LLID value stored in the LLID of the preamble 21, and decrypts the GATE message from the DA of the MAC header 22 to the FCS 27 with the selected decryption key. Meanwhile, when the encryption information stored in the encryption designation bit of the LLID of the control information 25-1 to 25-m of the GATE message indicates that the frame is encrypted, the decrypting unit 35 selects a decryption key indicated by the key information stored in the key designation bit of the LLID from among the decryption keys corresponding to the LLID value stored in the LLID, and decrypts the frame from the grant number/flag of the control information 25-1 to 25-m to the last Grant#4 Length of the control information 25-1 to 25-m with the selected decryption key.

The GATE processing unit 331 determines whether the grant setting information stored in the grant information of the control information 25-1 to 25-m is for a logical link set on itself or not, based on the LLID value stored in the LLID of the control information 25-1 to 25-m of the GATE message. When the grant setting information stored in the grant information of the control information 25-1 to 25-m is for a logical link set on itself, the GATE processing unit 331 determines the uplink frame transmission timing based on the grant setting information.

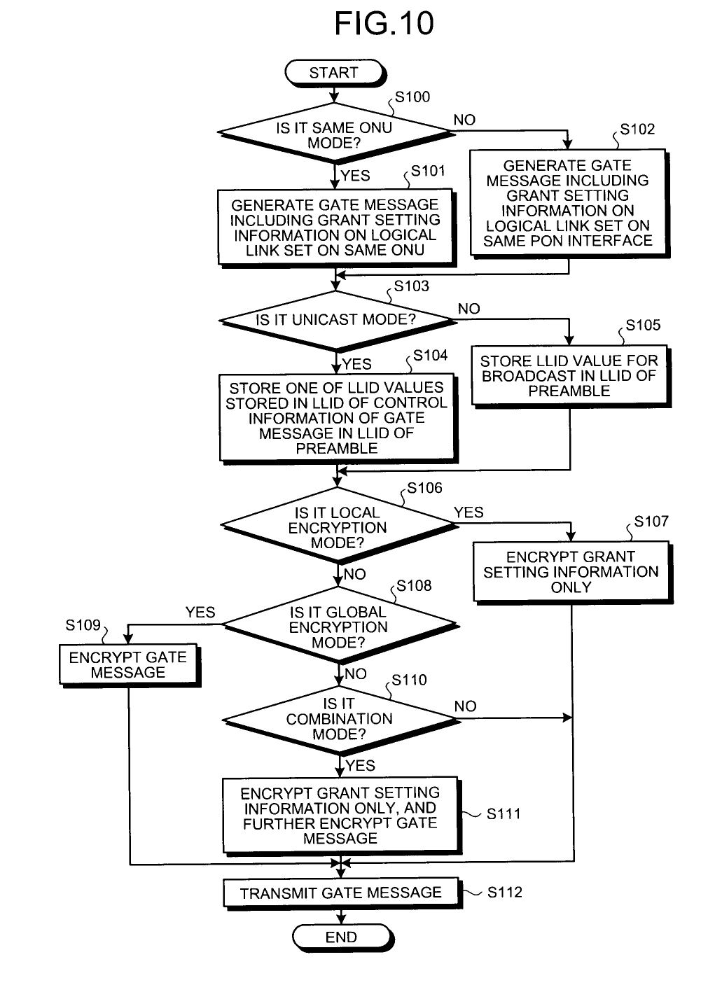

The operation of a GATE message transmission process performed by the OLT 1 according to the embodiment 1 will be explained with reference to a flowchart shown in FIG. 10. At the time for generating a GATE message, the GATE generating unit 133 determines whether the setting value of the grant setting information storing register indicates the same ONU mode (Step S100). When the setting value of the grant setting information storing register indicates the same ONU mode (Yes at Step S100), the GATE generating unit 133 generates a GATE message including the grant setting information on all logical links set on the same ONU 3 (Step S101).

Specifically, the GATE generating unit 133 recognizes logical links set on each ONU 3 from the logical link management information stored in the PON control unit 13, and extracts grant setting information for all recognized logical links from the grant setting information determined by the DBA unit 132. The GATE generating unit 133 stores the LLID value indicating each logical link in the LLID of the control information 25-1 to 25-m of the GATE message, and stores the grant setting information of the number of grants in the grant information of the control information 25-1 to 25-m. Furthermore, the GATE generating unit 133 stores corresponding information in the MAC header 22, the Opcode 23, the time stamp 24, the padding (Pad) 26, and the frame sequence check (FCS) 27 of the GATE message, thus generating the GATE message. The GATE generating unit 133 outputs the generated GATE message to the MAC unit 14.

When the setting value of the grant setting information storing register does not indicate the same ONU mode (which means that it indicates the same PON mode) (No at Step S100), the GATE generating unit 133 generates a GATE message including the grant setting information on all logical links set on the same PON interface (Step S102).

Specifically, the GATE generating unit 133 extracts grant setting information for all logical links of the same PON interface from the grant setting information determined by the DBA unit 132. The GATE generating unit 133 stores the LLID value indicating each logical link in the LLID of the control information 25-1 to 25-m of the GATE message, and stores the grant setting information of the number of grants in the grant information of the control information 25-1 to 25-m. Furthermore, the GATE generating unit 133 stores corresponding information in the MAC header 22, the Opcode 23, the time stamp 24, the padding (Pad) 26, and the frame sequence check (FCS) 27 of the GATE message, thus generating the GATE message. The GATE generating unit 133 outputs the generated GATE message to the MAC unit 14.

The MAC unit 14 determines whether the setting value of the LLID setting register indicates the unicast mode (Step S103). When the setting value of the LLID setting register indicates the unicast mode (Yes at Step S103), the MAC unit 14 stores one of the LLID values stored in the LLID of the control information 25-1 to 25-m of the GATE message in the LLID of the preamble 21 (Step S104). For example, the MAC unit 14 stores the LLID value stored in the LLID of the control information 25-1 of the GATE message in the LLID of the preamble 21. Then, the MAC unit 14 stores corresponding information in the preamble 21 of the GATE message, and outputs it to the encrypting unit 15.

When the setting value of the LLID setting register does not indicate the unicast mode (which means that it indicates the broadcast mode) (No at Step S103), the MAC unit 14 stores the LLID value for broadcast in the LLID of the preamble 21 (Step S105). Then, the MAC unit 14 stores corresponding information in the preamble 21 of the GATE message, and outputs it to the encrypting unit 15.

The encrypting unit 15 determines whether the setting value of the encryption register indicates the local encryption mode (Step S106). When the setting value of the encryption register indicates the local encryption mode (Yes at Step S105), the encrypting unit 15 encrypts only the grant setting information of the GATE message (Step S107). Specifically, the encrypting unit 15 encrypts the frame from the grant number/flag of the control information 25-1 to 25-m to the last Grant#n Length of the control information 25-1 to 25-m with one of the encryption keys managed in association with the LLID value stored in the LLID of the control information 25-1 to 25-m of the GATE message, and stores the encryption information indicating that the frame is encrypted and the key information for identifying the encryption key used when encrypting the frame in the encryption designation bit and the key designation bit at the upper 2 bits of the LLID of the control information 25-1 to 25-m, respectively. The encrypting unit 15 outputs the encrypted GATE message to the optical transceiving unit 16.

When the setting value of the encryption register does not indicate the local encryption mode (No at Step S106), the encrypting unit 15 determines whether the setting value of the encryption register indicates the global encryption mode (Step S108). When the setting value of the encryption register indicates the global encryption mode (Yes at Step S108), the encrypting unit 15 encrypts the GATE message (Step S109). Specifically, the encrypting unit 15 encrypts the GATE message from the DA of the MAC header 22 to the FCS 27 with one of the encryption keys managed in association with the LLID value stored in the LLID of the preamble 21, and stores the encryption information indicating that the frame is encrypted and the key information for identifying the encryption key used when encrypting the frame in the encryption designation bit and the key designation bit at the unused areas of the preamble 21, respectively. The encrypting unit 15 outputs the encrypted GATE message to the optical transceiving unit 16.

When the setting value of the encryption register does not indicate the global encryption mode (No at Step S108), the encrypting unit 15 determines whether the setting value of the encryption register indicates the combination encryption mode (Step S110). When the setting value of the encryption register indicates the combination encryption mode (Yes at Step S110), the encrypting unit 15 encrypts the grant setting information alone, and then further encrypts the GATE message (Step S111). Specifically, the encrypting unit 15 encrypts the frame from the grant number/flag of the control information 25-1 to 25-m to the last Grant#n Length of the control information 25-1 to 25-m with one of the encryption keys managed in association with the LLID value stored in the LLID of the control information 25-1 to 25-m of the GATE message, and stores the encryption information indicating that the frame is encrypted and the key information for identifying the encryption key used when encrypting the frame in the encryption designation bit and the key designation bit at the upper 2 bits of the LLID of the control information 25-1 to 25-m, respectively. After that, the encrypting unit 15 encrypts the GATE message from the DA of the MAC header 22 to the FCS 27 with one of the encryption keys managed in association with the LLID value stored in the LLID of the preamble 21, and stores the encryption information indicating that the frame is encrypted and the key information for identifying the encryption key used when encrypting the frame in the encryption designation bit and the key designation bit at the unused areas of the preamble 21, respectively. The encrypting unit 15 outputs the encrypted GATE message to the optical transceiving unit 16.

When the setting value of the encryption register does not indicate the combination encryption mode (No at Step S110), the encrypting unit 15 stores encryption information indicating that the encryption is not performed in the encryption designation bit of the LLID of the control information 25-1 to 25-m of the GATE message and the encryption designation bit at the unused areas of the preamble 21 without performing the encryption. After storing the encryption information in the encryption designation bit, the encrypting unit 15 outputs the GATE message to the optical transceiving unit 16.

The optical transceiving unit 16 converts the GATE message of an electrical signal input from the encrypting unit 15 into an optical signal and transmits it to the optical transmission medium 7 (Step S112).

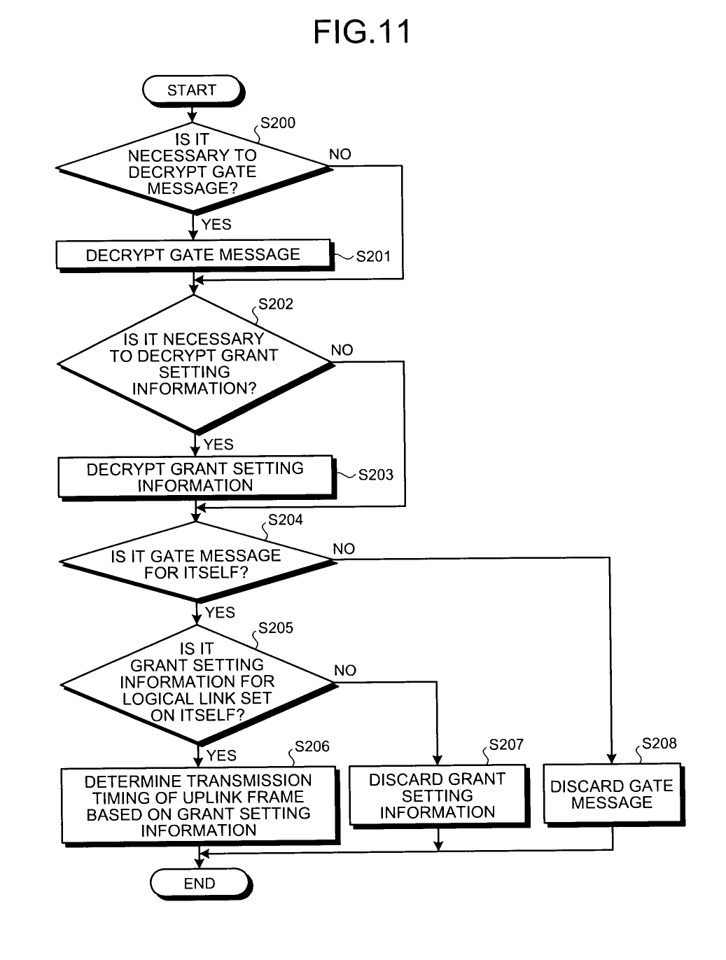

The operation of a GATE message reception process performed by the ONU 3 will be explained with reference to a flowchart shown in FIG. 11. The optical transceiving unit 37 converts the GATE message of an optical signal transmitted from the OLT 1 into an electrical signal and stores it in the frame buffer unit 36.

The decrypting unit 35 reads out the GATE message stored in the frame buffer unit 36, and determines whether a decryption of the GATE message is necessary (Step S200). When the decryption of the GATE message is necessary, the decrypting unit 35 decrypts the GATE message (Step S201). Specifically, when encryption information stored in the encryption designation bit at the unused areas of the preamble 21 of the GATE message indicates that the encryption is performed on the GATE message, the decrypting unit 35 selects a decryption key indicated by the key information stored in the key designation bit at the unused area of the preamble 21 from among the decryption keys corresponding to the LLID value stored in the LLID of the preamble 21, and decrypts the GATE message from the DA of the MAC header 22 to the FCS 27 with the selected decryption key.

When the decryption of the GATE message is not necessary, or after decrypting the GATE message, the decrypting unit 35 determines whether a decryption of the grant setting information is necessary (Step S202). When the decryption of the grant setting information is necessary, the decrypting unit 35 decrypts the grant setting information (Step S203). Specifically, when the encryption information stored in the encryption designation bit of the LLID of the control information 25-1 to 25-m of the GATE message indicates that the frame is encrypted, the decrypting unit 35 selects a decryption key indicated by the key information stored in the key designation bit of the LLID from among the decryption keys corresponding to the LLID value stored in the LLID, and decrypts the frame from the grant number/flag of the control information 25-1 to 25-m to the last Grant#4 Length of the control information 25-1 to 25-m with the selected decryption key.

When the decryption of the grant setting information is not necessary, or after decrypting the grant setting information, the decrypting unit 35 outputs the GATE message to the MAC unit 34. The MAC unit 34 determines whether the GATE message is for itself (Step S204). Specifically, the decrypting unit 35 determines that the GATE message is for itself when the LLID value stored in the LLID of the preamble 21 of the GATE message matches with the LLID value indicating a logical link set on itself or the LLID value for broadcast, and determines that the GATE message is not for itself when the LLID value stored in the LLID of the preamble 21 of the GATE message does not match with the LLID value indicating a logical link set on itself nor the LLID value for broadcast.

Upon determining that the GATE message is for itself, the MAC unit 34 outputs the GATE message to the GATE processing unit 331. The GATE processing unit 331 determines whether the grant setting information stored in the grant information of the control information 25-1 to 25-m is for a logical link set on itself or not, based on the LLID value stored in the LLID of the control information 25-1 to 25-m of the GATE message (Step S205). When the grant setting information stored in the grant information of the control information 25-1 to 25-m is for a logical link set on itself, the GATE processing unit 331 determines the uplink frame transmission timing based on the grant setting information, and ends the process (Step S206). After that, the PON control unit 33 transmits the MAC frame to the OLT 1 at the uplink frame transmission timing determined by the GATE processing unit 331. On the other hand, when the grant setting information stored in the grant information of the control information 25-1 to 25-m is not for a logical link set on itself, the GATE processing unit 331 discards the grant setting information (Step S207).

On the other hand, upon determining that the GATE message is not for itself, the MAC unit 34 discards the grant setting information, and ends the process (Step S208).

In this manner, in the embodiment 1, the GATE generating unit 133 of the OLT 1 generates a GATE message in which control information of a plurality of logical links, which is a set of a logical link identifier for identifying a logical link and grant information for controlling a timing for the ONU 3 to transmit an MAC frame through a logical link indicated by the logical link identifier, is stored in a single MAC frame for each logical link set on the same ONU 3 or each logical link set on the same PON interface. When a logical link indicated by the logical link identifier in the control information of the logical links stored in the GATE message indicates a logical link that is set on itself, the GATE processing unit 331 of the ONU 3 controls a timing for transmitting an MAC frame based on the grant information in the control information. With this scheme, it is possible to transfer least necessary information as the control information with a less bandwidth, compared with a case of transmitting the grant information of a plurality of logical links with a GATE message of a separate MAC frame for each logical link, making it possible to secure a communication bandwidth on the PON interface.

Furthermore, in the embodiment 1, the encrypting unit 15 of the OLT 1 encrypts the grant information of the control information with an encryption key associated with the logical link identifier of the control information, and encrypts the MAC frame, which is the GATE message, with an encryption key associated with the logical link identifier stored in the preamble. The decrypting unit 35 of the ONU 3 decrypts the MAC frame with a decryption key associated with the logical link identifier stored in the preamble, and decrypts the grant information of the control information with an encryption key associated with the logical link identifier of the control information. With this scheme, it is possible to decrypt only the grant information of the logical link set on itself even when a logical link identifier for broadcast is stored in the preamble, thus enhancing the security.

### Embodiment 2

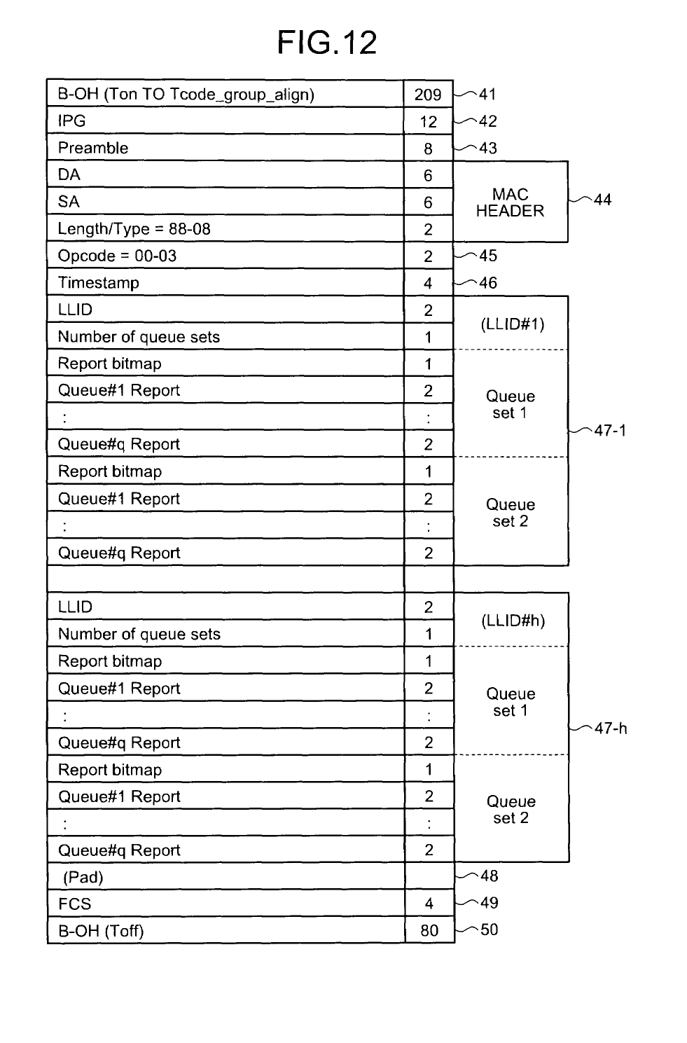

An embodiment 2 of the present invention will be explained with reference to FIGS. 12 to 19. An EPON system according to the embodiment 2 is same as the EPON system according to the embodiment 1 shown in FIG. 1, and therefore, its explanation will be omitted.

Firstly, a method of storing queue length information in the REPORT message according to the present invention will be explained. FIG. 12 is a schematic diagram illustrating a format of the REPORT message used in the EPON system according to the present invention. The REPORT message used in the EPON system according to the present invention shown in FIG. 12 shows a case of transmitting queue length information on h (h is a positive integer) logical links to the ONU 3. The REPORT message is configured with a 209-byte burst overhead (B-OH) 41, a 12-byte IGP 42, an 8-byte preamble 43, a 14-byte MAC header 44, a 2-byte Opcode 45, a 4-byte time stamp 46, a {s(2q+1)+3}-byte control information 47-1 to 47-h, a padding (Pad) 48, a 4-byte frame sequence check (FCS) 49, and a burst overhead (B-OH) 50, where s is the number of queue sets per logical link and q is the number of queues per queue set. In FIG. 12, s=2.

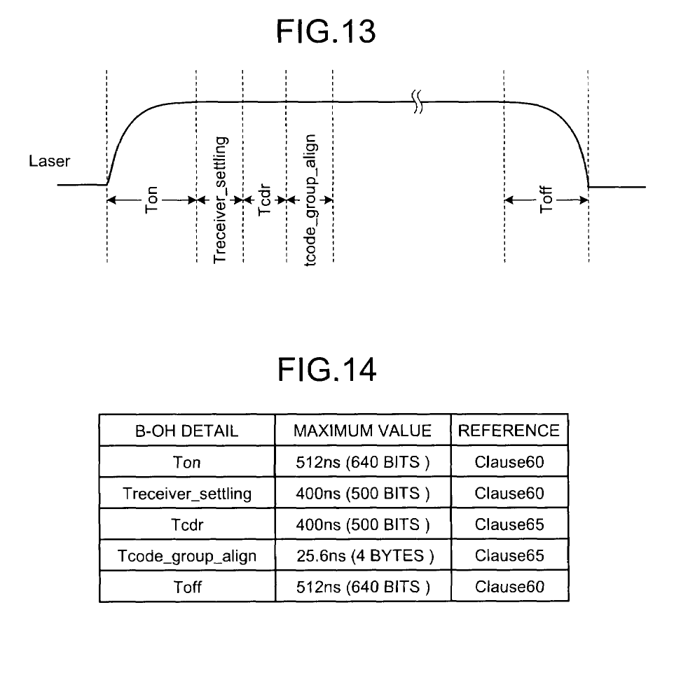

As shown in FIG. 13, in Nonpatent Literature 1, it is defined to transmit a burst overhead configured with Ton, Treceiver_settling, Tcdr, and Tcode_group_align before transmitting an MAC frame used in an uplink communication from the ONU 3 to the OLT 1, and to transmit a burst overhead configured with Toff after transmitting the MAC frame. Furthermore, in Chapters 60 and 65 of Nonpatent Literature 1, maximum values for Ton, Treceiver_settling, Tcdr, Tcode_group_align, and Toff are defined, as shown in FIG. 14.

The burst overhead 41 of the REPORT message shown in FIG. 12 is an area obtained by converting the maximum values of Ton, Treceiver_settling, Tcdr, and Tcode_group_align into the number of bytes, and the burst overhead 50 is an area obtained by converting the maximum value of Toff into the number of bytes.

The MAC header 44 is configured with a 6-byte DA for storing a destination MAC address of a GATE message, a 6-byte SA for storing a transmission source MAC address of the GATE message, and a 2-byte Type/Length for storing type information (88-08) meaning an MAC control message.

The Opcode 45 stores a code (00-03) indicating that it is a REPORT message. The time stamp 46 stores time information.

The control information 47-1 to 47-h is configured with a 2-byte LLID for storing an LLID value for identifying a logical link indicated by the control information stored in the field of the control information and a queue length information field for storing queue length information indicating the data accumulation amount of a queue with respect to the logical link (Number of queue sets, queue set 1 (Report bitmap, Queue#1 Report, . . . , Queue#q Report), queue set 2 (Report bitmap, Queue#1 Report, . . . , Queue#q Report)).

The Pad 48 is an area for adjusting a frame length such that the frame length of the REPORT message (from the MAC header 44 to the FCS 49) becomes at least 64 bytes, in which a value 0 is stored. The FCS 49 stores a code for detecting an error in the REPORT message.

In this manner, in the REPORT message of the EPON system according to the present invention, the LLID for storing the LLID value for identifying which logical link the queue length information stored in the queue length information field is for is provided in the control information 47-1 to 47-h, to store the queue length information on the h logical links in a single REPORT message. With this scheme, the frame length of the REPORT message used in the EPON system according to the present invention can be expressed in the number of bytes as

Frame length of REPORT message=B-OH+44+h{3+s(2q+1)} including a burst overhead, a 12-byte IPG, and an 8-byte preamble, where B-OH is the burst overhead length, h is the number of logical links per ONU3, s is the number of queue sets per logical link, and q is the number of queues per queue set.

Furthermore, in the REPORT message of the EPON system according to the present invention, the number of bytes of a payload of the REPORT message is variable according to the number of logical links h, the number of queue sets per link s, and the number of queues per queue set q to store the pieces of queue length information on h logical links in a single REPORT message. Therefore, if the frame length of the REPORT message exceeds the predetermined maximum frame length of the MAC frame, the frame of the REPORT message is divided into a plurality of MAC frames.

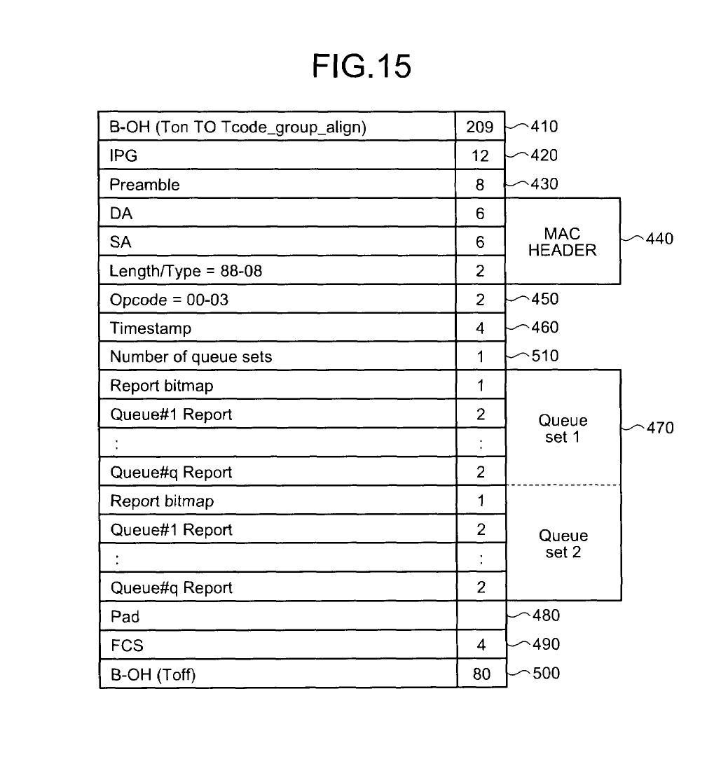

FIG. 15 is a schematic diagram illustrating a format of the REPORT message used in the conventional EPON system described in Nonpatent Literature 1. As shown in FIG. 15, the conventional REPORT message is configured with a 209-byte burst overhead (B-OH) 410, a 12-byte IGP 420, an 8-byte preamble 430, a 14-byte MAC header 440, a 2-byte Opcode 450, a 4-byte time stamp 460, a 1-byte Number of queue sets 510, control information 470, a {(2q+1)+1}-byte control information 470, a padding (Pad) 480, a 4-byte frame sequence check (FCS) 490, and a burst overhead (B-OH) 500, where q is the number of queues per queue set. The burst overhead 410, the IGP 420, the preamble 430, the MAC header 440, the Opcode 450, the time stamp 460, the padding 480, the FCS 490, and the burst overhead 500 are same as the burst overhead 41, the IGP 42, the preamble 43, the MAC header 44, the Opcode 45, the time stamp 46, the padding 48, the FCS 49, and the burst overhead 50 shown in FIG. 12. The difference is that only the control information 470 of a single logical link is set in the frame of the REPORT message, and in the control information 470, the LLID of the control information 47 in the REPORT message according to the present invention shown in FIG. 12 is deleted. In other words, the REPORT message used in the conventional EPON system shown in FIG. 15 notifies the queue length information on h logical links with h 64-byte MAC frames, while the REPORT message used in the EPON system according to the present invention notifies the queue length information on h logical links with a single MAC frame.

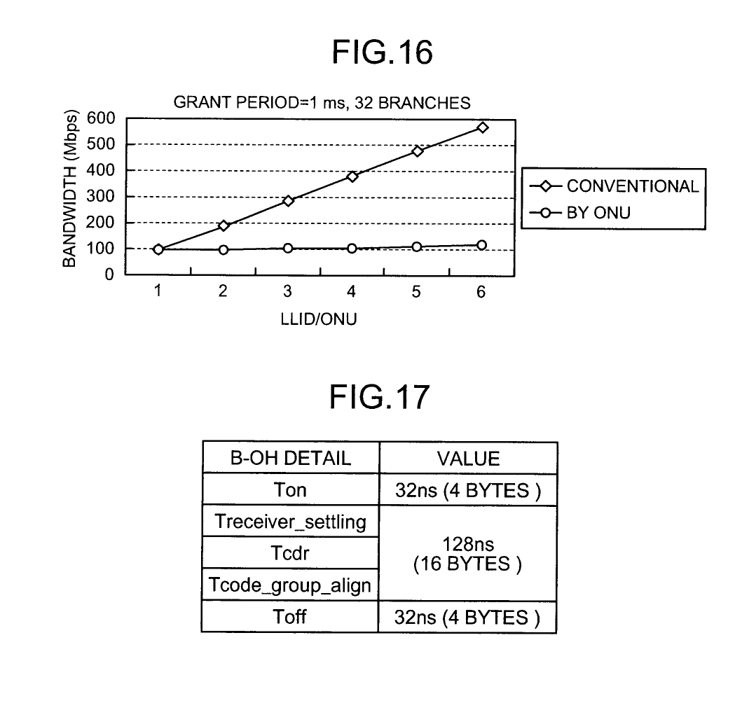

FIG. 16 is a graph showing a bandwidth required for the REPORT message when the burst overhead length is such that Ton is set to 640 bits, Treceiver_settling is set to 500 bits, Tcdr is set to 500 bits, Tcode_group_align is set to 4 bytes, and Toff is set to 640 bits, the number of ONUs connected to the PON interface is set to 32, the number of queue sets per logical link s is set to 2, the number of queues per queue set q is set to 4, and a period of generating the REPORT message is set to 1 ms.

In FIG. 16, the vertical axis represents the bandwidth, and the horizontal axis represents the number of logical links belonging to a single ONU 3. The symbol “⋄” indicates the required bandwidth when using the REPORT message of the conventional EPON system shown in FIG. 15, and the symbol “o” indicates the required bandwidth when using the REPORT message of the EPON system according to the present invention shown in FIG. 12.

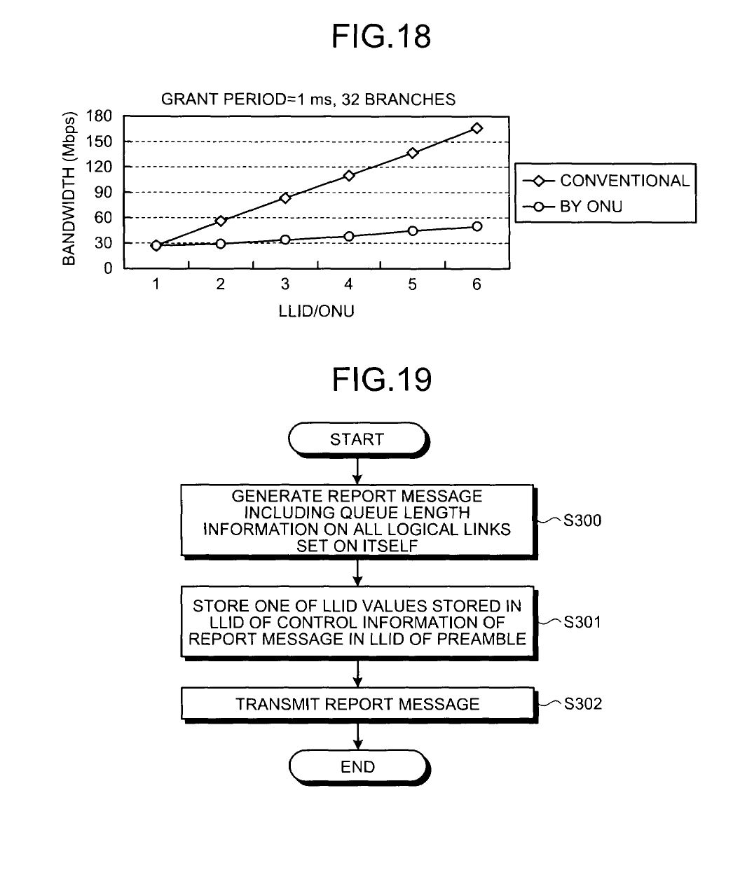

The burst overhead length shown in FIG. 4 is the specification of the maximum values, and in the practical usage, it is common to use values smaller than the maximum values. For example, if the burst overhead length is such that Ton is set to 4 bytes, Treceiver_settling is set to 16 bytes, Tcdr is set to 16 bytes, Tcode_group_align is set to 16 bytes, and Toff is set to 4 bytes, as shown in FIG. 17, the required bandwidth for the REPORT message when the number of ONUs connected to the PON interface is set to 32, the number of queue sets per logical link s is set to 2, the number of queues per queue set q is set to 4, and the period of generating the REPORT message is set to 1 ms is obtained as the graph shown in FIG. 18.

In FIG. 18, the vertical axis represents the bandwidth, and the horizontal axis represents the number of logical links belonging to a single ONU 3. The symbol “⋄” indicates the required bandwidth when using the REPORT message of the conventional EPON system shown in FIG. 15, and the symbol “o” indicates the required bandwidth when using the REPORT message of the EPON system according to the present invention shown in FIG. 12.

As can be seen from FIGS. 16 and 18, if the conditions of the burst overhead length are the same, the case of using the REPORT message according to the present invention requires less bandwidth than the case of using the conventional REPORT message, and as the number of logical links belonging to a single ONU 3 increases, the effect of suppressing the bandwidth by using the REPORT message according to the present invention increases.

The operation of a REPORT message transmission process performed by the ONU 3 according to the embodiment 2 will be explained with reference to a flowchart shown in FIG. 19. At the time for generating a REPORT message, the REPORT generating unit generates a REPORT message including queue length information on all logical links set on itself (the ONU 3) (Step S300).

Specifically, the REPORT generating unit 332 recognizes a state of a queue on all logical links set on the ONU 3 by monitoring the frame buffer unit 36. The REPORT generating unit 332 generates queue length information on all logical links set on itself from the recognized state of the queue. The REPORT generating unit 332 stores the LLID value indicating each of the logical links in the LLID of the control information 47-1 to 47-h of the REPORT message, and stores the queue length information on a logical link indicated by the LLID value in the control information 47-1 to 47-h for each queue set. Furthermore, the REPORT generating unit 332 stores corresponding information in the MAC header 44, the Opcode 45, the time stamp 46, the padding (Pad) 48, and the frame sequence check (FCS) 49 of the REPORT message, thus generating the REPORT message.

The REPORT generating unit 332 outputs the generated REPORT message to the MAC unit 34. The MAC unit 34 stores one of the LLID values stored in the LLID of the control information 47-1 to 47-h of the REPORT message in the preamble 43 (Step S301). For example, the MAC unit 34 stores the LLID value stored in the LLID of the control information 47-1 of the REPORT message in the preamble 43. Furthermore, the MAC unit 14 stores corresponding information in the preamble 43 of the REPORT message, and outputs it to the frame buffer unit 36.

The frame buffer unit 36 stores the REPORT message. The optical transceiving unit 37 converts the REPORT message stored in the frame buffer unit 36 into an optical signal according to the frame transmission timing determined based on the grant setting information notified by the GATE message from the OLT 1, and transmits the optical signal to the optical transmission medium 7 (Step S302).

The operation of a REPORT message reception process in the OLT 1 will be explained. The optical transceiving unit 16 converts the received REPORT message into an electrical signal, and outputs it to the MAC unit 14. The MAC unit 14 confirms that the REPORT message is from an ONU 3 that is under its management and that there is no data error in the REPORT message based on the LLID value stored in the preamble 43 of the REPORT message, various pieces of information stored in the MAC header 44, and the code stored in the FCS 49, and then outputs the REPORT message to the REPORT processing unit 131.

The REPORT processing unit 131 extracts the control information 47-1 to 47-h of the REPORT message, and outputs the queue length information for all logical links included in the REPORT message with a set of LLID values stored in the LLID of the control information 47-1 to 47-h and the queue length information to the DBA unit 132. The DBA unit 132 generates the grant setting information for each logical link using a predetermined algorithm, based on the queue length information for all logical links input from the REPORT processing unit 131.

In this manner, in the embodiment 2, the REPORT generating unit 332 of the ONU 3 generates a REPORT message in which the control information, which is a set of a logical link identifier for identifying a logical link and queue length information indicating a queue accumulation amount for each queue set corresponding to a logical link indicated by the logical link identifier, is stored in a single MAC frame, and transmits the REPORT message to the OLT 1. With this scheme, it is possible to transfer least necessary information as the control information with a less bandwidth, compared with a case of transmitting the queue length information of a plurality of logical links with a REPORT message of a separate MAC frame for each logical link, making it possible to secure a communication bandwidth on the PON interface.

### Embodiment 3

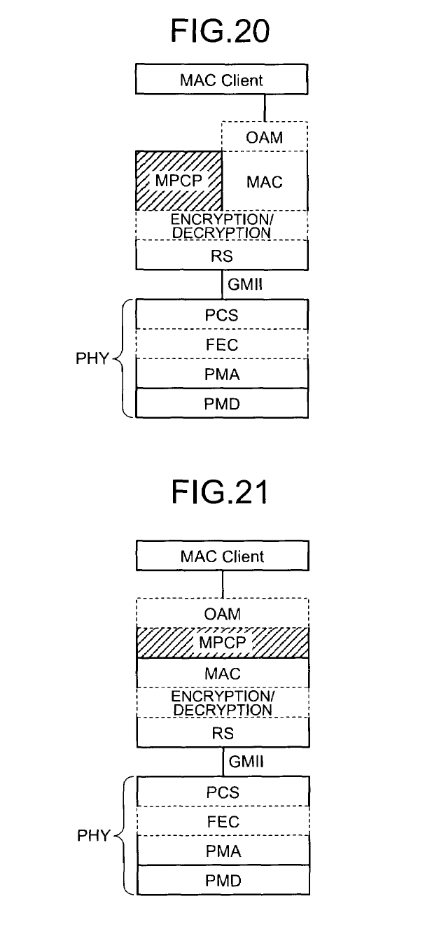

An embodiment 3 of the present invention will be explained with reference to FIGS. 20 to 27. FIG. 20 is a schematic diagram for explaining a protocol stack of an EPON system according to the embodiment 3. As shown in FIG. 20, the protocol stack of the EPON system according to the embodiment 3 is configured with an MAC Client, an OAM (Operations, Administration, and Maintenance), an MPCP (Multi-Point MAC Control), an MAC (Media Access Control), an encryption/decryption, an RS (Reconciliation Sublayer), a GMII (Gigabit Media Independent Interface), and a PHY (Physical Layer Device), and handles the MPCP and the MAC uniformly. The PHY is configured with a PCS (Physical Coding Sublayer), an FEC (Forward Error Correction), a PMA (Physical Medium Attachment), and a PMD (Physical Medium Dependent).

On the other hand, FIG. 21 is a schematic diagram for explaining the protocol stack of the conventional EPON system. The protocol stack of the conventional EPON system is configured with an MAC Client, an OAM, an MPCP, an MAC, an encryption/decryption, an RS, a GMII, and a PHY. The PHY is configured with a PCS, an FEC, a PMA, and a PMD, and the MPCP takes an upper position of the MAC.

The PON control unit that processes the GATE message and the REPORT message is equivalent to the MPCP. As shown in FIG. 21, in the protocol stack of the conventional EPON system, the MPCP takes an upper position than the MAC. Therefore, the GATE message and the REPORT message processed at the MPCP are transferred by an MAC frame.

In the MAC frame, there must be provided with a 12-byte IPG, an 8-byte preamble, a 14-byte MAC header (a 6-byte destination address, a 6-byte transmission source address, and a 2-byte Type/Length), and a 4-byte FCS.

On the other hand, in the protocol stack of the EPON system according to the embodiment 3 shown in FIG. 20, the overhead associated with the MAC frame is removed by deleting the IPG, the preamble, the MAC header, and the FCS required in the protocol stack of the conventional EPON system and alternatively providing a 1-byte physical layer delimiter, by handling the MPCP and the MAC layer uniformly instead of putting the MPCP at an upper position of the MAC layer. In addition, in FIGS. 20 and 21, the OAM, the FEC, and the encryption/decryption are optional.

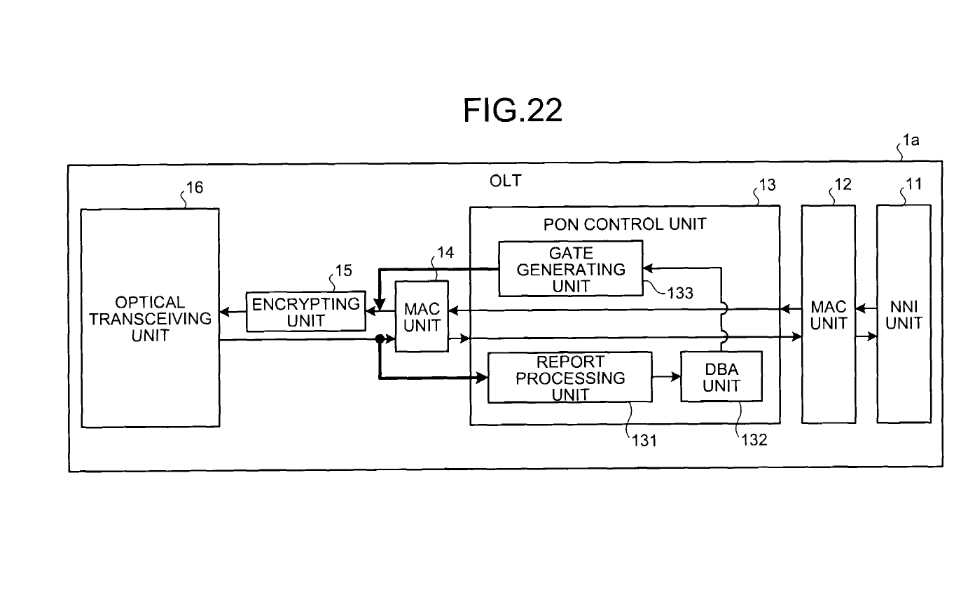

The EPON system according to the embodiment 3 includes an OLT 1a and an ONU 3a instead of the OLT 1 and the ONU 3 of the EPON system according to the embodiment 1. FIG. 22 is a block diagram illustrating a configuration of the OLT 1a according to the embodiment 3. The OLT 1a shown in FIG. 22 has the same function as the OLT 1 according to the embodiment 1 shown in FIG. 8. However, because the protocol stack is different, the output destination of the GATE message generated by the GATE generating unit 133 is not the MAC unit 14 but the encrypting unit 15, and the REPORT message is directly input from the optical transceiving unit 16 to the REPORT processing unit 131 without the MAC unit 14.

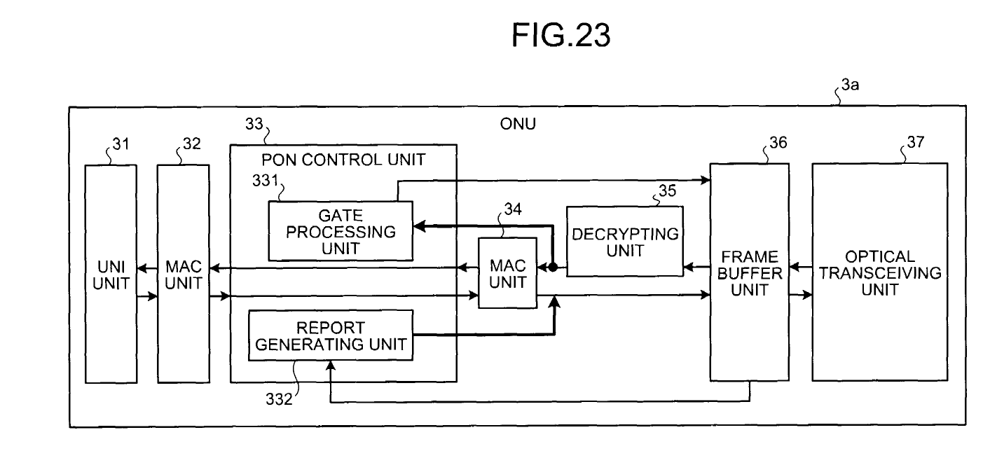

FIG. 23 is a block diagram illustrating a configuration of the ONU 3a according to the embodiment 3. The ONU 3a shown in FIG. 23 has the same function as the ONU 3 according to the embodiment 1 shown in FIG. 9. However, because the protocol stack is different, the output destination of the GATE message decrypted by the decrypting unit 35 is not the MAC unit 34 but the GATE processing unit 331, and the output destination of the REPORT message generated by the REPORT generating unit 332 is the frame buffer unit 36.

In this manner, the difference between the embodiment 3 and the above-described embodiment 1 and embodiment 2 is that the formats of the GATE message and the REPORT message are different by handling the MPCP and the MAC at the same layer in the protocol stack, and this difference alone will be explained.

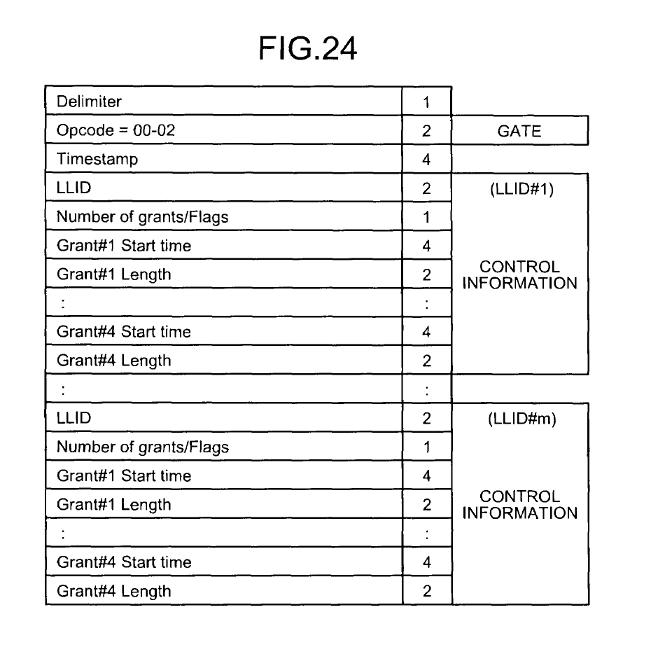

FIG. 24 is a schematic diagram illustrating a format of the GATE message according to the embodiment 3. As shown in FIG. 24, the GATE message according to the embodiment 3 is configured with a 1-byte delimiter (Delimiter), a 2-byte Opcode (Opcode), a 4-byte Timestamp, and m pieces of control information consisting of LLID and grant setting information (Number of grants/Flags, Grant#1 Start Time, Grant#1 Length, Grant#2 Start Time, Grant#2 Length, Grant#3 Start Time, Grant#3 Length, Grant#4 Start Time, Grant#4 Length), deleting the preamble 21, the MAC header 22, the Pad 26, and the FCS 27 from the GATE message according to the embodiment 1 shown in FIG. 2 and adding the 1-byte delimiter.

The frame length of the GATE message in the case of using the GATE message shown in FIG. 24 can be expressed in the number of bytes as

Frame length of GATE message=7+m(3+6n)

where m is the number of logical links and n is the number of grants per logical link.

In the embodiment 3, the GATE generating unit 133 stores the same information as the information of the control information 24-1 to 24-m of the GATE message according to the embodiment 1 shown in FIG. 2 in the m pieces of control information of the GATE message shown in FIG. 24, and outputs it to the encrypting unit 15.

There is no preamble in the GATE message according to the embodiment 3. Therefore, the encryption cannot be performed with a key associated with the LLID value stored in the LLID of the preamble as is the case in the embodiment 1. As a result, the setting value of the encryption register is the local encryption mode or the unencryption mode. When the setting value of the encryption register indicates the local encryption mode, the encrypting unit 15 encrypts the grant information of the control information including the LLID value with an encryption key managed in association with the LLID value stored in the LLID of the control information.

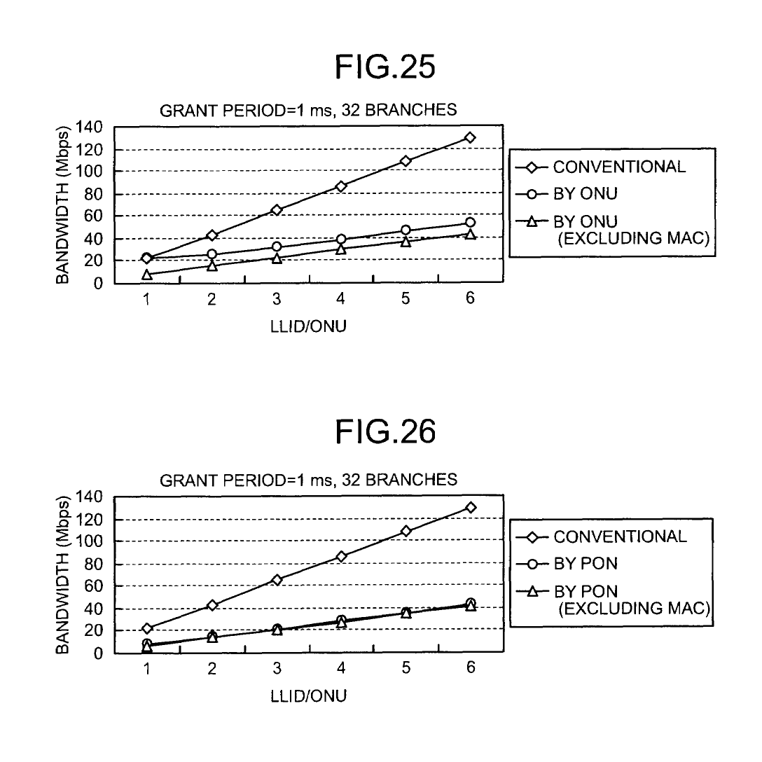

FIGS. 25 and 26 show bandwidths required for the GATE messages when the number of ONUs 3 connected to the PON interface (covered by the OLT 1) is set to 32, the number of grants per logical link n is set to “4”, and a period of generating the GATE message is set to 1 ms.

In FIG. 25, the vertical axis represents the bandwidth, and the horizontal axis represents the number of logical links belonging to a single ONU 3a. The symbol “⋄” indicates the required bandwidth when using the GATE message of the conventional EPON system shown in FIG. 3, the symbol “o” indicates the required bandwidth when using the GATE message of the EPON system according to the embodiment 1 shown in FIG. 2, which stores the grant setting information in units of ONU by the (method 1), and the symbol “Δ” indicates the required bandwidth when using the GATE message of the EPON system according to the embodiment 3 shown in FIG. 24, which stores the grant setting information in units of ONU by the (method 1).

In FIG. 26, the vertical axis represents the bandwidth, and the horizontal axis represents the number of logical links belonging to a single ONU 3a. The symbol “⋄” indicates the required bandwidth when using the GATE message of the conventional EPON system shown in FIG. 3, the symbol “o” indicates the required bandwidth when using the GATE message of the EPON system according to the embodiment 1 shown in FIG. 2, which stores the grant setting information in units of PON by the (method 2), and the symbol “Δ” indicates the required bandwidth when using the GATE message of the EPON system according to the embodiment 3 shown in FIG. 24, which stores the grant setting information in units of PON by the (method 2).

As shown in FIGS. 25 and 26, the case of using the GATE message of the EPON system according to the embodiment 3 in which the grant setting information is stored by the (method 1) or the (method 2) requires less bandwidth than the case of using the GATE message of the conventional EPON system, and furthermore, requires even less bandwidth than the case of using the GATE message according to the embodiment 1.

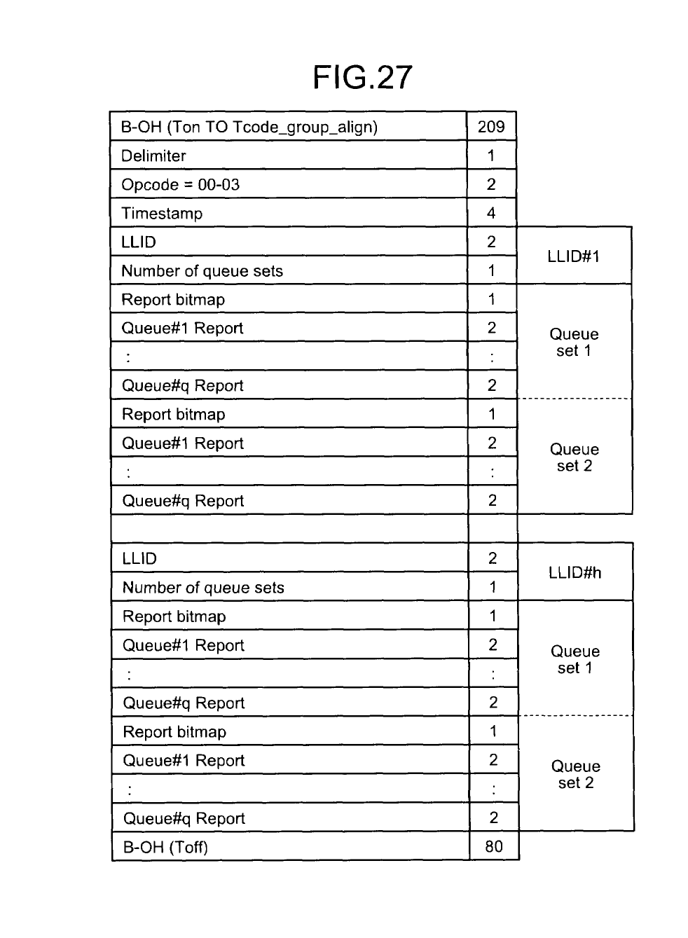

The REPORT message according to the embodiment 3 will be explained below. FIG. 27 is a schematic diagram illustrating a format of the REPORT message according to the embodiment 3. As shown in FIG. 27, the REPORT message according to the embodiment 3 is configured with a 209-byte B-OH consisting of Ton, Treceiver_settling, Tcdr, and Tcode_group_align, a 1-byte delimiter (Delimiter), a 2-byte Opcode (Opcode), a 4-byte Timestamp, and h pieces of control information consisting of a 2-byte LLID for storing an LLID value for identifying a logical link indicated by the control information stored in the field of the control information and a queue length information field for storing queue length information indicating the data accumulation amount of a queue with respect to the logical link (Number of queue sets, queue set 1 (Report bitmap, Queue#1 Report, . . . , Queue#q Report), queue set 2 (Report bitmap, Queue#1 Report, . . . , Queue#q Report)), deleting the IPG 42, the preamble 43, the MAC header 44, the Pad 48, and the FCS 49 from the GATE message according to the embodiment 2 shown in FIG. 12 and adding the 1-byte delimiter.

The frame length of the REPORT message in the case of using the REPORT message shown in FIG. 27 can be expressed in the number of bytes as

Frame length of REPORT message=B-OH+5+h{3+2(2q+1)}

where B-OH is the burst overhead length, h is the number of logical links per ONU 3, s is the number of queue sets per logical link, and q is the number of queues per queue set.

In the embodiment 3, the REPORT generating unit 332 stores the same information as the information of the control information 27-1 to 27-h of the REPORT message according to the embodiment 2 shown in FIG. 12 in the h pieces of control information of the REPORT message shown in FIG. 27, and outputs it to the frame buffer unit 36.

In this manner, in the embodiment 3, the MAC layer and the MPCP layer are handled uniformly in the protocol stack, and after the delimiter of the physical layer, a GATE message in which control information of a plurality of logical links, which is a set of a logical link identifier for identifying a logical link and grant information for controlling a timing for the ONU 3 to transmit an MAC frame through a logical link indicated by the logical link identifier, is added for each logical link set on the same ONU 3 or each logical link set on the same PON interface or a REPORT message in which the control information, which is a set of a logical link identifier for identifying a logical link and queue length information indicating a queue accumulation amount for each queue set corresponding to a logical link indicated by the logical link identifier, is added for all logical links set on itself is employed. Therefore, it is possible to transfer least necessary information as the control information with a less bandwidth, compared with a case of transmitting the grant information of each logical link with a separate MAC frame or a case of storing the grant information of each logical link in a payload of a single MAC frame, making it possible to secure a communication bandwidth on the PON interface.

### Embodiment 4

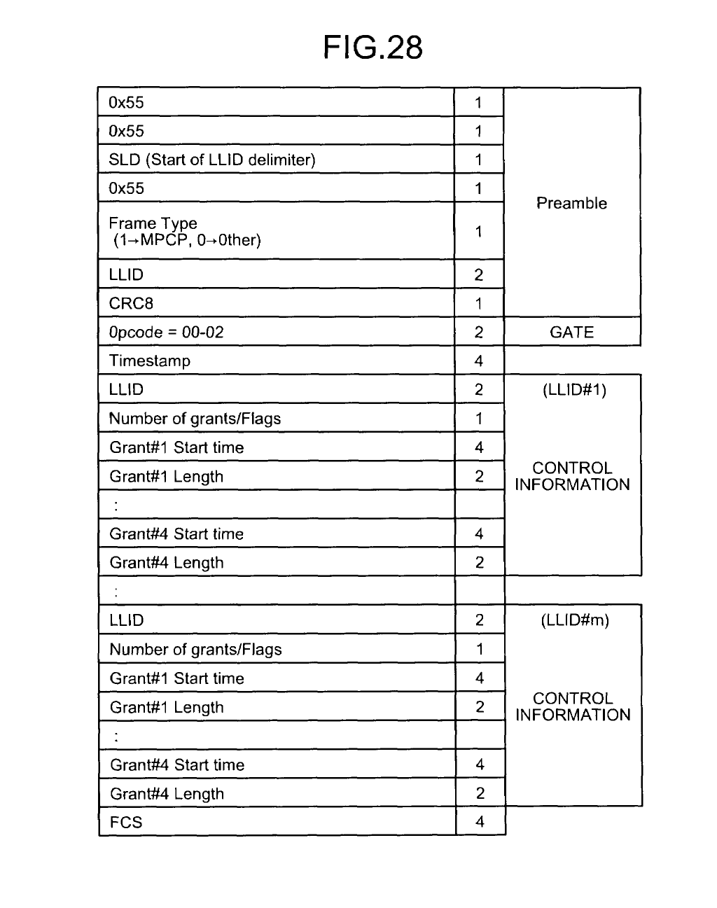

An embodiment 4 of the present invention will be explained with reference to FIGS. 28 to 31. The protocol stack of the EPON system according to the embodiment 4 is the same as the protocol stack according to the embodiment 3 shown in FIG. 20, and therefore, its explanation will be omitted here. Furthermore, the EPON system according to the embodiment 4 is the same as the EPON system according to the embodiment 3 including the OLT 1a according to the embodiment 3 shown in FIG. 22 and the ONU 3a shown in FIG. 23 instead of the OLT 1 and the ONU 3 of the EPON system according to the embodiment 1, and therefore, its explanation will be omitted here.

The difference between the embodiment 4 and the above-described embodiment 3 is that the formats of the GATE message and the REPORT message are different, and this difference alone will be explained.

FIG. 28 is a schematic diagram illustrating a format of the GATE message according to the embodiment 4. As shown in FIG. 28, the GATE message according to the embodiment 4 is configured with an 8-byte preamble, a 2-byte Opcode (Opcode), a 4-byte Timestamp, m pieces of control information consisting of LLID and grant setting information (Number of grants/Flags, Grant#1 Start Time, Grant#1 Length, Grant#2 Start Time, Grant#2 Length, Grant#3 Start Time, Grant#3 Length, Grant#4 Start Time, Grant#4

Length), and a 4-byte frame sequence check (FCS). The GATE message according to the embodiment 4 shown in FIG. 28 includes an 8-byte preamble instead of the 1-byte delimiter of the GATE message according to the embodiment 3 shown in FIG. 24, and is added with an FCS for storing a code for detecting an error of the GATE message after the m-th control information. Details on the preamble will be described later.

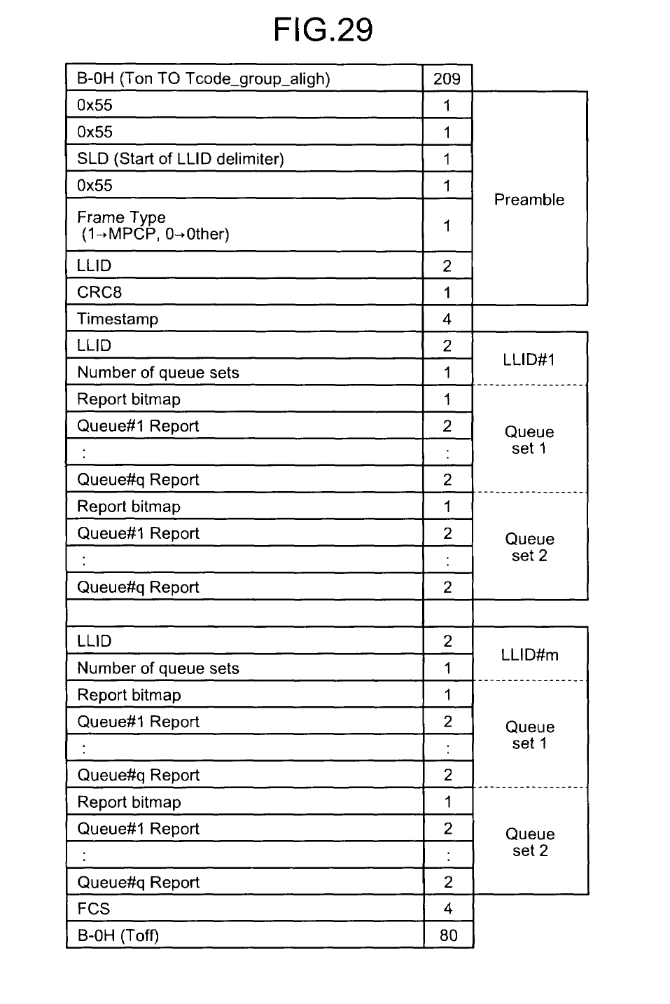

FIG. 29 is a schematic diagram illustrating a format of a REPORT message according to the embodiment 4. As shown in FIG. 29, the REPORT message according to the embodiment 4 is configured with a 209-byte B-OH consisting of Ton, Treceiver_settling, Tcdr, and Tcode_group_align, an 8-byte preamble, a 2-byte Opcode (Opcode), a 4-byte Timestamp, and h pieces of control information consisting of a 2-byte LLID for storing a 2-byte LLID for storing an LLID value for identifying a logical link indicated by the control information stored in the field of the control information and a queue length information field for storing queue length information indicating the data accumulation amount of a queue with respect to the logical link (Number of queue sets, queue set 1 (Report bitmap, Queue#1 Report, . . . , Queue#q Report), queue set 2 (Report bitmap, Queue#1 Report, . . . , Queue#q Report)). The REPORT message according to the embodiment 4 shown in FIG. 29 includes an 8-byte preamble instead of the 1-byte delimiter of the REPORT message according to the embodiment 3 shown in FIG. 27, and is added with an FCS for storing a code for detecting an error of the REPORT message after the h-th queue length information field.

The preambles of the GATE message shown in FIG. 28 and the REPORT message shown in FIG. 29 are configured with unused areas located at the first, the second, and the fourth bytes for storing a reserve value “0x55”, an SLD (Start of LLID Delimiter) located at the third byte for storing information indicating that an LLID is stored in the preamble, a frame type (Frame Type) located at the fifth byte for storing the type of a frame, an LLID located at the sixth and the seventh bytes, and a CRC 8 located at the eighth byte for storing a code for a code error check for areas from the SLD to the LLID. The GATE message according to the embodiment 4 uses the unused area located at the fifth byte of the preamble 21 according to the embodiment 1 as the frame type.

The type of the frame stored in the frame type is information indicating whether the frame is an MPCP frame or not. Specifically, using the lowermost bit of the frame type, for example, if the lowermost bit of the frame type is “1”, it indicates that the frame is an MPCP frame, and if the lowermost bit of the frame type is “0”, it indicates that the frame is a frame other than the MPCP frame. The LLID of the preamble according to the embodiment 4 has no particular meaning, although the LLID of the preamble according to the embodiment 1 stores the value of a logical link identifier (LLID: Logical Link Identifier) for identifying a logical link.

When transmitting a frame, the GATE generating unit 133 of the OLT 1a sets “1” to the lowermost bit of the frame type at the fifth byte of the preamble of the GATE message for an MPCP frame to be transmitted. The MAC unit 14 sets “0” to the lowermost bit of the frame type of the preamble of a frame other than the MPCP frame to be transmitted.

Upon receiving a frame from the OLT 1a, the decrypting unit 35 of the ONU 3a decrypts the received frame as appropriate, and then determines a transfer destination of the received frame by referring to the lowermost bit of the frame type at the fifth byte of the preamble of the frame. When the lowermost bit of the frame type of the preamble is “1”, the decrypting unit 35 determines that the received frame is an MPCP frame, and transfers the received frame to the GATE processing unit 331. On the other hand, when the lowermost bit of the frame type of the preamble is “0”, the decrypting unit 35 determines that the received frame is a frame other than the MPCP frame, and transfers the received frame to the MAC unit 34.

When transmitting a frame, the REPORT generating unit 332 of the ONU 3a sets “1” to the lowermost bit of the frame type at the fifth byte of the preamble of the REPORT message for an MPCP frame to be transmitted. The MAC unit 34 sets “0” to the lowermost bit of the frame type of the preamble of a frame other than the MPCP frame to be transmitted.

Upon receiving a frame from the ONU 3a, the optical transceiving unit 16 of the OLT 1a determines a transfer destination of the received frame by referring to the lowermost bit of the frame type at the fifth byte of the preamble of the frame. When the lowermost bit of the frame type of the preamble is “1”, the optical transceiving unit 16 determines that the received frame is an MPCP frame, and transfers the received frame to the REPORT processing unit 131. On the other hand, when the lowermost bit of the frame type of the preamble is “0”, the optical transceiving unit 16 determines that the received frame is a frame other than the MPCP frame, and transfers the received frame to the MAC unit 14.

The frame length of the GATE message in the case of using the GATE message shown in FIG. 28 can be expressed in the number of bytes as

Frame length of GATE message=18+m(3+6n)

where m is the number of logical links and n is the number of grants per logical link.

The frame length of the REPORT message in the case of using the REPORT message shown in FIG. 29 can be expressed in the number of bytes as

Frame length of REPORT message=B-OH+16+h{3+2(2q+1)}

where B-OH is the burst overhead length, h is the number of logical links per ONU 3a, s is the number of queue sets per logical link, and q is the number of queues per queue set.

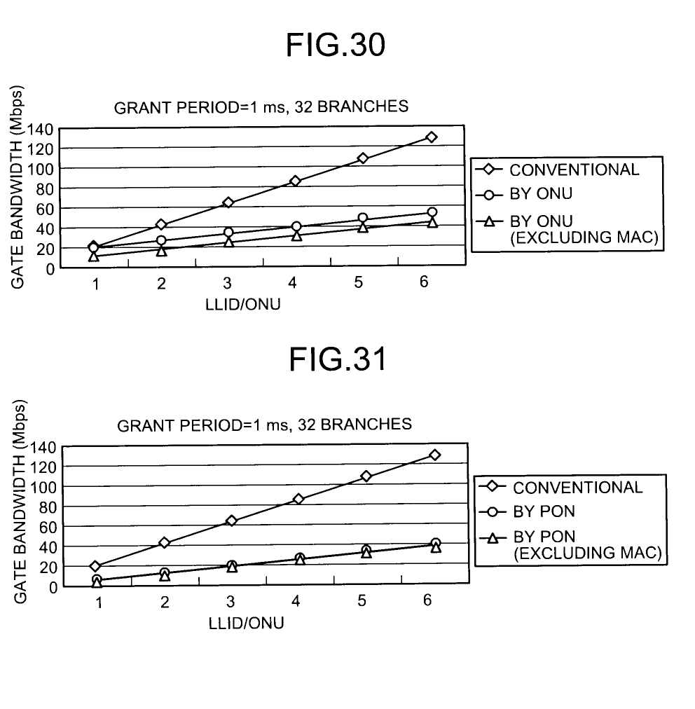

FIGS. 30 and 31 show bandwidths required for the GATE messages when the number of ONUs 3a connected to the PON interface (covered by the OLT 1a) is set to 32, the number of grants per logical link n is set to “4”, and a period of generating the GATE message is set to 1 ms.

In FIG. 30, the vertical axis represents the bandwidth, and the horizontal axis represents the number of logical links belonging to a single ONU 3a. The symbol “⋄” indicates the required bandwidth when using the GATE message of the conventional EPON system shown in FIG. 3, the symbol “o” indicates the required bandwidth when using the GATE message of the EPON system according to the embodiment 1 shown in FIG. 2, which stores the grant setting information in units of ONU by the (method 1), and the symbol “A” indicates the required bandwidth when using the GATE message of the EPON system according to the embodiment 4 shown in FIG. 28, which stores the grant setting information in units of ONU by the (method 1).

In FIG. 31, the vertical axis represents the bandwidth, and the horizontal axis represents the number of logical links belonging to a single ONU 3a. The symbol “⋄” indicates the required bandwidth when using the GATE message of the conventional EPON system shown in FIG. 3, the symbol “o” indicates the required bandwidth when using the GATE message of the EPON system according to the embodiment 1 shown in FIG. 2, which stores the grant setting information in units of PON by the (method 2), and the symbol “A” indicates the required bandwidth when using the GATE message of the EPON system according to the embodiment 4 shown in FIG. 28, which stores the grant setting information in units of PON by the (method 2).

As shown in FIGS. 30 and 31, the case of using the GATE message of the EPON system according to the embodiment 4 in which the grant setting information is stored by the (method 1) or the (method 2) requires less bandwidth than the case of using the GATE message of the conventional EPON system, and furthermore, requires even less bandwidth than the case of using the GATE message according to the embodiment 1.

In this manner, in the embodiment 4, the MAC layer and the MPCP layer are handled uniformly in the protocol stack, and after the preamble of the MAC layer, a GATE message in which in which control information of a plurality of logical links, which is a set of a logical link identifier for identifying a logical link and grant information for controlling a timing for the ONU 3a to transmit an MAC frame through a logical link indicated by the logical link identifier, is added for each logical link set on the same ONU 3a or each logical link set on the same PON interface or a REPORT message in which the control information, which is a set of a logical link identifier for identifying a logical link and queue length information indicating a queue accumulation amount for each queue set corresponding to a logical link indicated by the logical link identifier, is added for all logical links set on itself is employed. Therefore, it is possible to transfer least necessary information as the control information with a less bandwidth, compared with a case of transmitting the grant information of each logical link with a separate MAC frame or a case of storing the grant information of each logical link in a payload of a single MAC frame, making it possible to secure a communication bandwidth on the PON interface. In addition, because the unused byte of the preamble is used for representing the type of the frame, a frame arrangement at the time of receiving a frame becomes easy.

### Embodiment 5

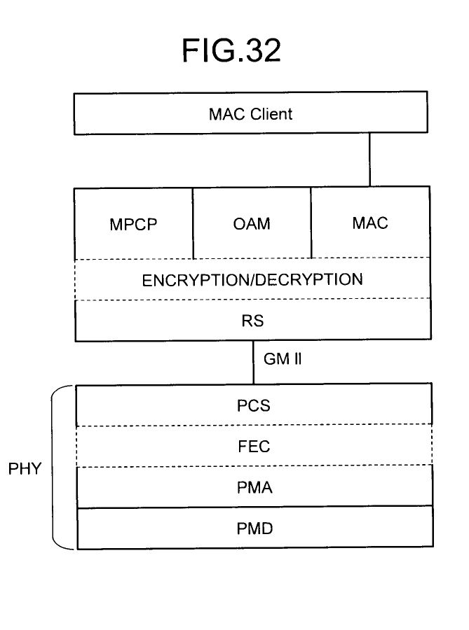

An embodiment 5 of the present invention will be explained with reference to FIGS. 32 to 35. FIG. 32 is a schematic diagram for explaining a protocol stack of an EPON system according to the embodiment 5. As shown in FIG. 32, the protocol stack of the EPON system according to the embodiment 5 is configured with an MAC Client, an OAM (Operations, Administration, and Maintenance), an MPCP (Multi-Point MAC Control), an MAC (Media Access Control), an encryption/decryption, an RS (Reconciliation Sublayer), a GMII (Gigabit Media Independent Interface), and a PHY (Physical Layer Device), and handles the MPCP, the OAM, and the MAC uniformly. The PHY is configured with a PCS (Physical Coding Sublayer), an FEC (Forward Error Correction), a PMA (Physical Medium Attachment), and a PMD (Physical Medium Dependent).

On the other hand, the protocol stack of the EPON system according to the embodiment 3 shown in FIG. 20 is configured with an MAC Client, an OAM, an MPCP, an MAC, an encryption/decryption, an RS, a GMII, and a PHY. The PHY is configured with a PCS, an FEC, a PMA, and a PMD, and the OAM takes an upper position of the MAC. Therefore, the OAM frame is transferred by the MAC frame.

In the MAC frame, there must be provided with a 12-byte IPG, an 8-byte preamble, a 14-byte MAC header (a 6-byte destination address, a 6-byte transmission source address, and a 2-byte Type/Length), and a 4-byte FCS.

On the other hand, in the protocol stack of the EPON system according to the embodiment 5 shown in FIG. 32, the overhead associated with the MAC frame is removed by deleting the IPG and the MAC header of the MAC frame required in the protocol stack of the EPON system according to the embodiment 3, by handling the OAM and the MAC layer uniformly instead of putting the OAM at an upper position of the MAC layer.

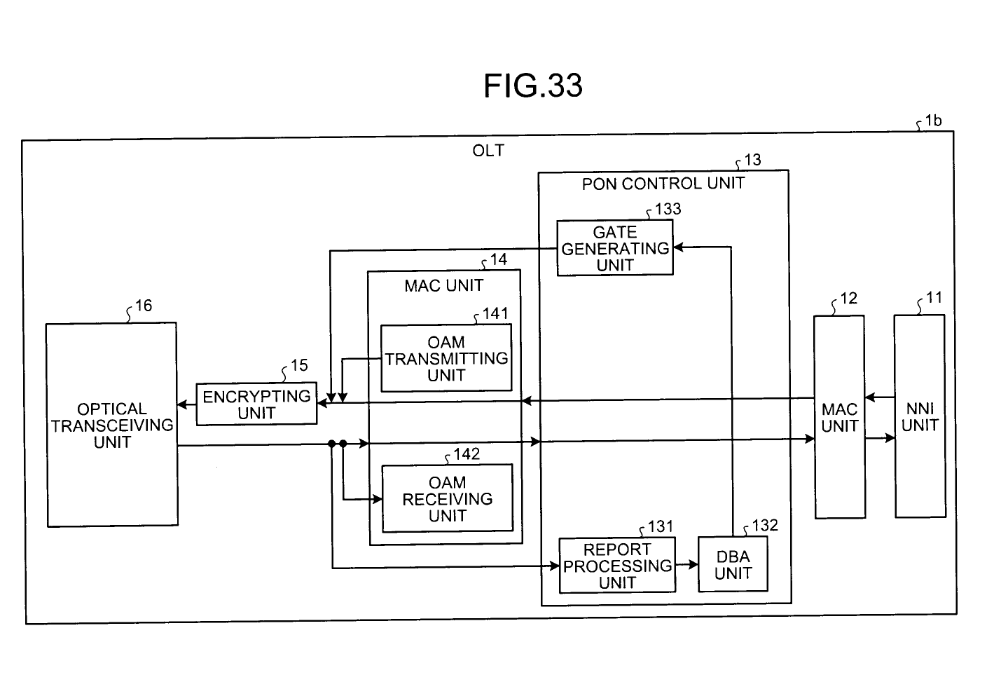

The EPON system according to the embodiment 5 includes an OLT 1b and an ONU 3b instead of the OLT 1a and the ONU 3a of the EPON system according to the embodiment 3. FIG. 33 is a block diagram illustrating a configuration of the OLT 1b according to the embodiment 5. The OLT 1b shown in FIG. 33 is virtually similar to the OLT 1a according to the embodiment 3 shown in FIG. 22, including an OAM transmitting unit 141 and an OAM receiving unit 142 for processing an OAM frame in the MAC unit 14. Furthermore, because the protocol stack is different between the OLT 1b and the OLT 1a, the output destination of an OAM frame generated by the OAM transmitting unit 141 is not the MAC unit 14 but the encrypting unit 15, and a received OAM frame is directly input from the optical transceiving unit 16 to the OAM receiving unit 142 without the MAC unit 14.

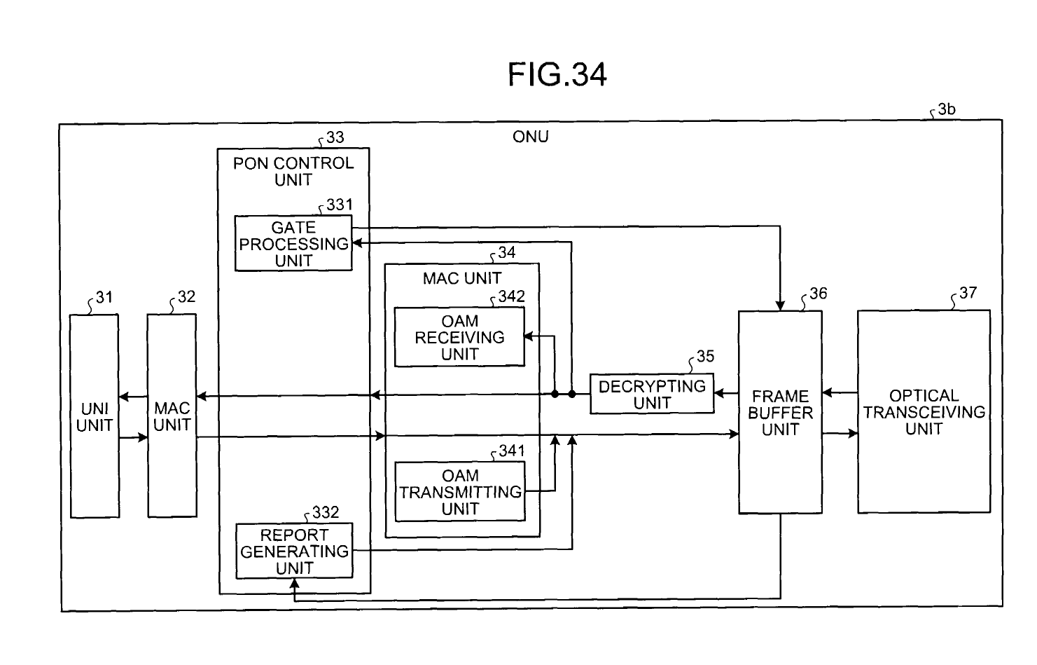

FIG. 34 is a block diagram illustrating a configuration of the ONU 3b according to the embodiment 5. The ONU 3b shown in FIG. 34 is virtually similar to the ONU 3a according to the embodiment 3 shown in FIG. 23, including an OAM transmitting unit 341 and an OAM receiving unit 342 for processing an OAM frame in the MAC unit 34. Furthermore, because the protocol stack is different between the ONU 1a and the ONU 1a, the output destination of an OAM frame decrypted by the decrypting unit 35 is the OAM receiving unit 342 in the MAC unit 34, and the output destination of an OAM frame generated by the OAM transmitting unit 341 is the frame buffer unit 36.

In this manner, the difference between the embodiment 5 and the above-described embodiment 3 is that the format of the OAM frame is different by handling the OAM and the MAC at the same layer in the protocol stack, and this difference alone will be explained.

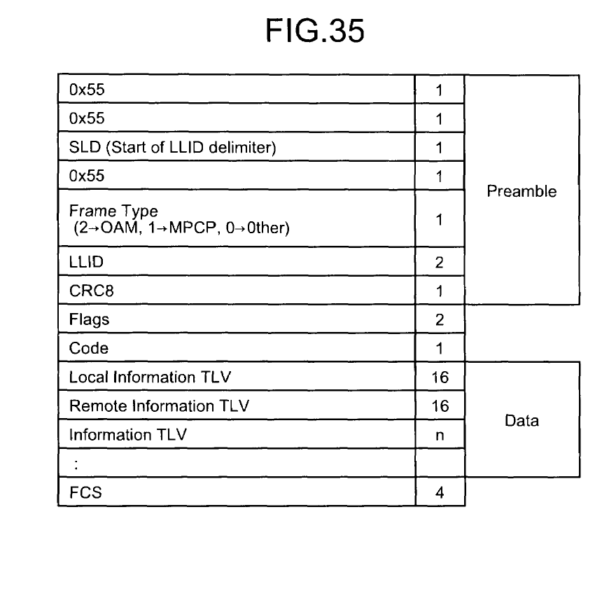

FIG. 35 is a schematic diagram illustrating a format of an OAM frame (Information OAMPDU) according to the embodiment 5. As shown in FIG. 35, the OAM frame according to the embodiment 5 is configured with an 8-byte preamble, a 2-byte flag (Flags), a 1-byte code (Code), an OAM data (Local Information TLV, Remote Information TLV, Information TLV), and a 4-byte frame check sequence (FCS). In other words, the OAM frame according to the embodiment 5 shows a configuration obtained by deleting the MAC header from a conventional OAM frame.

The preamble is configured with, in the same manner as the preambles of the GATE message and the REPORT message according to the embodiment 4, unused areas located at the first, the second, and the fourth bytes for storing a reserve value “0x55”, an SLD (Start of LLID Delimiter) located at the third byte for storing information indicating that an LLID is stored in the preamble, a frame type (Frame Type) located at the fifth byte for storing the type of a frame, an LLID located at the sixth and the seventh bytes, and a CRC 8 located at the eighth byte for storing a code for a code error check for areas from the SLD to the LLID.

The type of the frame stored in the frame type of the preamble of the OAM frame stores information indicating whether the frame is an OAM frame, an MPCP frame, or a frame other than the OAM frame and the MPCP frame. For example, if the lower 2 bits of the frame type is “2”, it indicates that the frame is an OAM frame, if the lower 2 bits of the frame type is “1”, it indicates that the frame is an MPCP frame, and if the lower 2 bits of the frame type is “0”, it indicates that the frame is a frame other than the OAM frame and the MPCP frame.

When transmitting a frame, the OAM transmitting unit 141 of the OLT 1b sets “2” to the lower 2 bits of the frame type at the fifth byte of the preamble for an OAM frame to be transmitted. The GATE generating unit 133 sets “1” to the lower 2 bits of the frame type at the fifth byte of the preamble for an MPCP frame to be transmitted. The MAC unit 14 sets “0” to the lower 2 bits of the frame type of the preamble for the other frames.

Upon receiving a frame from the OLT 1b, the decrypting unit 35 of the ONU 3b decrypts the received frame as appropriate, and then determines a transfer destination of the received frame by referring to the lower 2 bits of the frame type at the fifth byte of the preamble of the frame. When the lower 2 bits of the frame type of the preamble is “2”, the decrypting unit 35 determines that the received frame is an OAM frame, and transfers the received frame to the OAM receiving unit 342. When the lower 2 bits of the frame type of the preamble is “1”, the decrypting unit 35 determines that the received frame is an MPCP frame, and transfers the received frame to the GATE processing unit 331. When the lower 2 bits of the frame type of the preamble is “0”, the decrypting unit 35 determines that the received frame is a frame other than the OAM frame and the MPCP frame, and transfers the received frame to the MAC unit 34.

When transmitting a frame, the OAM transmitting unit 341 of the ONU 3b sets “2” to the lower 2 bits of the frame type at the fifth byte of the preamble for an OAM frame to be transmitted. The REPORT generating unit 332 sets “1” to the lower 2 bits of the frame type at the fifth byte of the preamble of the REPORT message for an MPCP frame to be transmitted. The MAC unit 34 sets “0” to the lower 2 bits of the frame type of the preamble for a frame other than the OAM frame and the MPCP frame.

Upon receiving a frame from the ONU 3b, the optical transceiving unit 16 of the OLT 1b determines a transfer destination of the received frame by referring to the lower 2 bits of the frame type at the fifth byte of the preamble. When the lower 2 bits of the frame type of the preamble is “2”, the optical transceiving unit 16 determines that the received frame is an OAM frame, and transfers the received frame to the OAM receiving unit 142. When the lower 2 bits of the frame type of the preamble is “1”, the optical transceiving unit 16 determines that the received frame is an MPCP frame, and transfers the received frame to the REPORT processing unit 131. When the lower 2 bits of the frame type of the preamble is “0”, the optical transceiving unit 16 determines that the received frame is a frame other than the OAM frame and the MPCP frame, and transfers the received frame to the MAC unit 14.

In this manner, in the embodiment 5, the OAM layer is handled uniformly with the MAC layer and the MPCP layer in the protocol stack, employing an OAM frame without an MAC header. Therefore, it is possible to transfer least necessary information with a less bandwidth as regular OAM information for a notification of setting information to the ONU and a notification of an alert and a Keep Alive from the ONU, compared with a case of transmitting an OAM frame as an MAC frame, making it possible to secure a communication bandwidth on the PON interface.

### INDUSTRIAL APPLICABILITY

As described above, the optical communication system according to the present invention is suitable for an optical communication system that connects one to a plurality of subscriber-side apparatuses having one to a plurality of subscriber terminals and a station-side apparatus that covers the subscriber-side apparatuses with an optical transmission medium, sets one to a plurality of logical links between the station-side apparatus and each of the subscriber-side apparatuses, and performs a data transfer with an MAC frame using the set logical link, and more particularly, for an optical communication system having a large number of set logical links.

1-28. (canceled)

29. An optical communication system comprising:
one to a plurality of subscriber-side apparatuses having one to a plurality of subscriber terminals;
a station-side apparatus that covers the subscriber-side apparatuses; and
an optical transmission medium that connects the subscriber-side apparatuses and the station-side apparatus, wherein
one to a plurality of logical links is set between the station-side apparatus and each subscriber-side apparatus,
a data transfer is performed between the station-side apparatus and the subscriber-side apparatus with a media access control frame through a set logical link, and
the station-side apparatus and the subscriber-side apparatus transmit control information of a plurality of set logical links by storing the control information in a single media access control frame.

30. The optical communication system according to claim 29, wherein
the station-side apparatus includes a GATE generating unit that stores control information of a plurality of logical links, which is a set of a logical link identifier for identifying a logical link and grant information for controlling a timing for the subscriber-side apparatus to transmit a media access control frame through a logical link indicated by the logical link identifier, in a single media access control frame, and
the subscriber-side apparatus includes a GATE processing unit that, when a logical link indicated by the logical link identifier in the control information of the logical links stored in the single media access control frame indicates a logical link that is set on the subscriber-side apparatus, controls a timing for transmitting a media access control frame based on the grant information in the control information.

31. The optical communication system according to claim 30, wherein
the GATE generating unit stores control information for each logical link set on a same subscriber-side apparatus in a single media access control frame.

32. The optical communication system according to claim 30, wherein
the GATE generating unit stores control information for each logical link set on a same passive optical network interface belonging to the optical communication system in a single media access control frame.

33. The optical communication system according to claim 31, wherein
the station-side apparatus further includes a media access control unit that stores a logical link identifier of any one of pieces of control information for each logical link in a preamble of a media access control frame.

34. The optical communication system according to claim 33, wherein
the media access control unit stores a logical link identifier indicating a broadcast in the preamble of the media access control frame.

35. The optical communication system according to claim 31, wherein
the station-side apparatus further includes an encrypting unit that encrypts the grant information in the control information by using an encryption key that is associated with the logical link identifier in the control information for each piece of control information, and
the subscriber-side apparatus further includes a decrypting unit that decrypts the grant information in the control information by using a decryption key that is associated with the logical link identifier in the control information for each piece of control information.

36. The optical communication system according to claim 35, wherein
the encrypting unit encrypts a media access control frame by using an encryption key that is associated with the logical link identifier stored in the preamble, and
the decrypting unit decrypts the media access control frame by using a decryption key that is associated with the logical link identifier stored in the preamble.

37. The optical communication system according to claim 30, wherein
the subscriber-side apparatus further includes a REPORT generating unit that stores control information, which is a set of a logical link identifier for identifying a logical link and queue length information indicating a queue accumulation amount for each queue set corresponding to a logical link indicated by the logical link identifier, in a single media access control frame.

38. The optical communication system according to claim 37, wherein
the REPORT generating unit stores the control information of all logical links set on the subscriber-side apparatus in a single media access control frame.

39. The optical communication system according to claim 38, wherein
the subscriber-side apparatus further includes a media access control unit that stores a logical link identifier of any one of pieces of control information for each logical link in a preamble of a media access control frame.

40. An optical communication system comprising:
one to a plurality of subscriber-side apparatuses having one to a plurality of subscriber terminals;
a station-side apparatus that covers the subscriber-side apparatuses; and
an optical transmission medium that connects the subscriber-side apparatuses and the station-side apparatus, wherein
one to a plurality of logical links is set between the station-side apparatus and each subscriber-side apparatus,
a data transfer is performed between the station-side apparatus and the subscriber-side apparatus with a media access control frame through a set logical link, and
the station-side apparatus and the subscriber-side apparatus equate a media access control layer and a multi-point control protocol layer with each other in a protocol stack, and transmit control information of a plurality of set logical links to a counterparty by attaching the control information following a delimiter of a physical layer.

41. A station-side apparatus configured to be connected to one to a plurality of subscriber-side apparatuses having one to a plurality of subscriber terminals via an optical transmission medium in an optical communication system, sets one to a plurality of logical links with each subscriber-side apparatus, and performs a data transfer with the subscriber-side apparatus with a media access control frame using a set logical link, the station-side apparatus comprising:
a GATE generating unit that transmits control information of a plurality of set logical links to the subscriber-side apparatus by storing the control information in a single media access control frame.

42. The station-side apparatus according to claim 41, wherein
the GATE generating unit stores control information of a plurality of logical links, which is a set of a logical link identifier for identifying a logical link and grant information for controlling a timing for the subscriber-side apparatus to transmit a media access control frame through a logical link indicated by the logical link identifier, in a single media access control frame.

43. The station-side apparatus according to claim 42, wherein
the GATE generating unit stores control information for each logical link set on a same subscriber-side apparatus in a single media access control frame.

44. The station-side apparatus according to claim 42, wherein
the GATE generating unit stores control information for each logical link set on a same passive optical network interface belonging to the station-side apparatus in a single media access control frame.

45. The station-side apparatus according to claim 43, further comprising:
a media access control unit that stores a logical link identifier of any one of pieces of control information for each logical link in a preamble of a media access control frame.

46. The station-side apparatus according to claim 45, wherein
the media access control unit stores a logical link identifier indicating a broadcast in the preamble of the media access control frame.

47. The station-side apparatus according to claim 43, further comprising:
an encrypting unit that encrypts the grant information in the control information by using an encryption key that is associated with the logical link identifier in the control information for each piece of control information.

48. The station-side apparatus according to claim 47, wherein
the encrypting unit encrypts a media access control frame by using an encryption key that is associated with the logical link identifier stored in the preamble.

49. A subscriber-side apparatus that has one to a plurality of subscriber terminals, is configured to be connected to a station-side apparatus via an optical transmission medium in an optical communication system, sets one to a plurality of logical links with the station-side apparatus, and performs a data transfer with the station-side apparatus with a media access control frame using a set logical link, the subscriber-side apparatus comprising:
a REPORT generating unit transmits control information of a plurality of set logical links to the station-side apparatus by storing the control information in a single media access control frame.

50. The subscriber-side apparatus according to claim 49, wherein
the REPORT generating unit stores control information, which is a set of a logical link identifier for identifying a logical link and queue length information indicating a queue accumulation amount for each queue set corresponding to a logical link indicated by the logical link identifier, in a single media access control frame.

51. The subscriber-side apparatus according to claim 50, wherein
the REPORT generating unit stores the control information of all logical links set on the subscriber-side apparatus in a single media access control frame.

52. The subscriber-side apparatus according to claim 51, further comprising:
a media access control unit that stores a logical link identifier of any one of pieces of control information for each logical link in a preamble of a media access control frame.

53. An optical communication system comprising:
one to a plurality of subscriber-side apparatuses having one to a plurality of subscriber terminals;
a station-side apparatus that covers the subscriber-side apparatuses; and
an optical transmission medium that connects the subscriber-side apparatuses and the station-side apparatus, wherein
one to a plurality of logical links is set between the station-side apparatus and each subscriber-side apparatus,
a data transfer is performed between the station-side apparatus and the subscriber-side apparatus with a media access control frame through a set logical link, and
the station-side apparatus and the subscriber-side apparatus equate a media access control layer and a multi-point control protocol layer with each other in a protocol stack, and transmit control information of a plurality of set logical links to a counterparty by attaching the control information following a preamble of the media access control layer.

54. The optical communication system according to claim 53, wherein
the station-side apparatus and the subscriber-side apparatus use an unused area of the preamble of the media access control layer as a frame type for storing a type of a frame, and
when transmitting a frame, the station-side apparatus and the subscriber-side apparatus stores information indicating whether the frame is a multi-point control protocol frame or not in the frame type, and when receiving a frame, identifies whether the frame is a multi-point control protocol frame or not based on information stored in the frame type of a received frame.

55. An optical communication system comprising:
one to a plurality of subscriber-side apparatuses having one to a plurality of subscriber terminals;
a station-side apparatus that covers the subscriber-side apparatuses; and
an optical transmission medium that connects the subscriber-side apparatuses and the station-side apparatus, wherein
one to a plurality of logical links is set between the station-side apparatus and each subscriber-side apparatus, a data transfer is performed between the station-side
apparatus and the subscriber-side apparatus with a media access control frame through a set logical link, and
the station-side apparatus and the subscriber-side apparatus equate a media access control layer, a multi-point control protocol layer, and an operations-administration-maintenance layer with each other in a protocol stack, and transmit control information of a plurality of set logical links to a counterparty by attaching the control information following a preamble of the media access control layer.

56. The optical communication system according to claim 55, wherein
the station-side apparatus and the subscriber-side apparatus use an unused area of the preamble of the media access control layer as a frame type for storing a type of a frame, and
when transmitting a frame, the station-side apparatus and the subscriber-side apparatus stores information indicating whether the frame is an operations-administration-maintenance frame, a multi-point control protocol frame or a frame other than the operations-administration-maintenance frame and the multi-point control protocol frame in the frame type, and when receiving a frame, identifies whether the frame is an operations-administration-maintenance frame, a multi-point control protocol frame or a frame other than the operations-administration-maintenance frame and the multi-point control protocol frame based on information stored in the frame type of a received frame.
